(19) United States
(12) Patent Application Publication
(10) Pub. No.: US 2026/0184600 A1
(43) Pub. Date: Jul. 2, 2026

(54) FILTER SYSTEM FOR HANDHELD CONTAINERS OF CONSUMABLE LIQUIDS

(71) Applicant: CAP ZERO, LLC, BATH, OH (US)

(72) Inventor: Richard D. Derosa, AKRON, OH (US)

(21) Appl. No.: 19/551,030

(22) Filed: Feb. 26, 2026

Related U.S. Application Data
(63) Continuation-in-part of application No. 19/194,427, filed on Apr. 30, 2025.
(60) Provisional application No. 63/644,224, filed on May 8, 2024.

(51) Int. Cl. C02F 1/00; B01D 29/05; B01D 29/13; B65D 47/08; B65D 51/24; C02F 101/30

(52) U.S. Cl. CPC C02F 1/002; B01D 29/05; B01D 29/13; B65D 47/088; B65D 51/24; B01D 2201/291; B01D 2201/301; B01D 2201/347; B01D 2201/4092; C02F 2101/30; C02F 2201/004; C02F 2201/005; C02F 2201/006

(57) ABSTRACT

A liquid filtration system compatible for mounting on numerous varieties of disposable and non-disposable plastic/metal containers and which filters out at least micro-particulates (e.g., plastics) introduced at least a part of the manufacturer bottling process when consumable liquid is inserted into the plastic containers. The filtration system now functions as the cap to the bottle to prevent leakage of the liquid from the bottle and to assure the user that the liquid being drawn from the bottle is filtered free of at least micro-particulates. The filtration system can employ a variety of replacement filters of differing lengths for utilization on containers of equally differing volumes and dimensions.

### RELATED APPLICATION DATA

This application is a Continuation-in-Part (CIP) of application Ser. No. 19/194,427 filed Apr. 30, 2025, and entitled FILTER SYSTEM FOR HANDHELD CONTAINERS OF CONSUMABLE LIQUIDS, which claims the benefit of U.S. Provisional Application No. 63/644,224 filed May 8, 2024, the disclosures of which are incorporated by reference herein, including the specifications. application Ser. No. 19/194,427 is also related to International Application No. PCT/US2025/027056 filed Apr. 30, 2025, and published on November 13, as WO 2025/235275.

### BACKGROUND

It is estimated that billions of disposable plastic water bottles are purchased and discarded annually in this country-a number that is sure to be far-exceeded worldwide. Accordingly, major world-wide health organizations and other concerned institutions have suggested that not only are the discarded empty containers a major environmental problem, but also particulates from the use of plastic containers which leach into the liquid during production, storage, transport, and/or user handling can also pose a serious threat to consumer health. Such minute plastic particles can then be consumed thereby causing negative health effects in the consumer such as cancer, dementia, and endocrine disruption.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture is a cap-based filtration system (also referred to as the cap filter system (or assembly)) which solves an existing problem in the marketplace and which is faced by consumers of liquids (e.g., water) from plastic bottles (e.g., disposable), by providing a particulate filtering system (e.g., micro-plastic particulates) at the point of consumption (e.g., at or near the container or bottle “cap” location or also referred to as the “bottle mouth”). The cap filtration system can be user-purchased and user-mounted to the user bottle, mounted to the bottle(s) at the bottle manufacturer as part of the manufacturing process of the bottle, and/or mounted to each liquid-filled bottle after insertion of the liquid, at the same or a different vendor. Thereafter, the user can purchase one or more new cap filtration systems as replacements for existing filtration systems or for application to newly-purchased disposable (plastic) bottles of liquid such as water.

Liquids, such as at least water, consumed from (disposable) plastic water bottles (e.g., portable, handheld, long distance carry or toting, etc.) can now be filtered at the consumer level to protect the consumer from the inadvertent consumption of undesirable particulates present in the liquid and/or plastic bottle from any number of processes, such as when the liquid is installed into the bottle, after the liquid has been installed and capped, from storage of the liquid/container combination, from temperature variation effects during storage and distribution, from distribution and handling processes, and from bottle components such as when affixing the bottle cap during manufacture, and/or removing the bottle cap at the consumer level, for example, to name a few avenues of possible particulate contamination.

A solution implements a cap filter system for a plastic (disposable) bottle (or non-disposable container) designed to be compatible with myriad types of water bottle (container) designs and structured to remove particulates (e.g., micro-plastics, ultra-plastics, nano-plastics, etc.) from the liquid (e.g., water) as the consumer causes (e.g., draws, pushes, etc.) water to flow through the cap filter system and from the bottle. Thus, the particulates are removed from the water as part of the process of drawing the liquid from the bottle for consumption, and in some instances, before consumption, but as could reside in the filtration system for the next consumption action.

Accordingly, the disclosed cap (filtration) system is compatible for mounting on numerous types of disposable (or non-disposable) containers (plastic or otherwise) via mounting methods such as using the bottle (container) cap threads, alternative clamp-on techniques (e.g., compression fitting pressed-on over the bottle opening, compression fitting pressed into and on the inside the bottle neck, and other similar techniques, such as adapters which enable mounting of the filtration system to a specific bottle or container) which enable a sealed attachment of the filtration system at/to the primary container opening.

The entire cap filtration system can be designed as a single-use system, which can be used once and then discarded separately from or entirely with the (e.g., empty) plastic container. The cap filtration system can be designed as a recyclable piece, separately, or along with the discarded plastic container. Moreover, the cap filtration system can be sold with, or installed on, each purchased bottle of water at the water/bottle supplier and/or at the consumer level. The cap filtration system can be designed as a non-reusable filtration system (a “permanently fixed filtration system”) where the filter is procured as a permanently installed (and thereby, non-replaceable). In this instance, the permanently fixed filtration system can be designed for entire replacement and disposable after a finite number of filtration processes (e.g., fifty, one hundred, two hundred, etc.).

The cap filtration system can be designed to capture the filter cartridge (denoted here as a standard-length filter) such that the cap fabrication process prevents replacement of the used cartridge filter. Alternatively, the filtration system can be designed to (removably) attach the filter cartridge such that the fabrication process of the cap filtration system further enables access to, and replacement of, a used inner filter cartridge with a new un-used filter cartridge.

The cap filtration system can be designed with the filter cartridge having an extended length (e.g., a greater length than the standard cap filter cartridge) such that a portion of the extended-length filter extends beyond the capture portion (of one end of the filter cartridge) and further down (then the standard-length filter) and into the bottle/container volume. The capture portion of the container can be a threaded section on the outside of the bottle neck portion for receiving and tightening to a compatible threaded cap filtration system.

The filtration system includes an attachment mechanism which attaches the filtration system to a container via threads at a typical container opening. An extension housing enables the implementation of the extended length filter subsystems which can extend portions of the filter cartridge though the container mouth and into predetermined points the container body, as well as enabling extension of a portion of the same filter cartridge above the container mouth. This capability of extended filter cartridges in the filtration system is provided in addition to filtration systems where the upper endcap portion of the installed cartridge is at the top of the container mouth. This enhanced filter media exposure to the longer cartridges by the container liquid facilitates greater exposure of the container liquid to the filter media for faster output (e.g., consumption) of the liquid and a possible longer life of the filter before recycling the entire system or replacing the used filtration system of a new filtration system, and potentially reusing the container, rather than readily discarding.

It is also contemplated that the capture portion of the container neck can be designed as a compression portion which is compatible to receiving a clamping-type or compression-type of cap filter system. The container neck is sufficiently strong to receive a compatible clamping section of the cap system to ultimately seat properly to provide a leak-proof area/surface that prevents water leakage during use. Accordingly, in the clamp-on embodiment, the cap system is not a thread-on design, but a compression design that can be forced onto the clamping section by the user for ready use.

The cap system can also be designed with a loosely-captured (or tethered) cap attached to the cap system, and that folds over the exit port (from which the user receives filtered water) of the cap system to prevent unwanted particulates to enter into the exit port and prevent fluid loss from the container when not in use. The tethered cap can be designed to be captured onto the cap system (e.g., via an accompanying tethered cap o-ring, when the user is not receiving liquid from the container) or such as by compression capture technique to a plastic lip (or rim) fabricated to engage the interior lip/edge of the tethered cap to retain the tethered cap for this specific purpose.

The cap system can also be designed to be fitted to engage only the outside surface of the neck of the plastic container, designed to be fitted to engage only an inside portion of the neck portion, and/or designed to slide into the inside of the neck portion of the container such that the cap system engages both the inside wall of the container and the outside surface at the neck portion for secured use.

It can also be the case that the filter and the cap system are separate components such that the used filter medium can be removed as a single unit from the cap filtration system and discarded, and a new replacement filter medium re-inserted into the cap system for renewed use and particulate (e.g., micro-plastics) filtering.

The cap design can be fabricated for compatibility with many different plastic bottle container sizes. Similarly, the filters/cartridges can be increased in dimensions for larger containers, as needed. Accordingly, filters may “last longer” (survive repeated use before needing to be replaced). Larger plastic disposable water containers can require larger cap systems and filters, such as for multi-gallon plastic bottles, metal jugs, multi-gallon glass jugs, multiple-gallon metal jugs, etc.

Fabrication of the cap system can be accomplished by machining some or all of the cap filtration system components, molding some or all of the cap filtration system components, digital printing some or all of the cap filtration system, or combination of any of the previously mentioned fabrication techniques of machining, molding, and/or digital printing.

Other plastic object fabrication techniques well-known in the industry can also be employed such as injection molding, blow molding, rotational molding, vacuum casting, plastic machining, fused deposition modeling, stereolithography, selective laser sintering, plastic extrusion, plastic pultrusion, plastic welding, and thermoforming, for example.

The disclosed architecture also finds application to disposable plastic bottle systems where the cap filtration system is not directly captured to the bottle neck, but captures to a hose or conduit extended a distance from the water container, such as a back-pack water container (e.g., pouch, bladder, etc.). In this alternative implementation, a hose can be fixed to the water bladder container system, and extended therefrom to the cap filtration system through which the user extracts/consumes filtered water. Such systems are employed by hikers, cyclists, runners, for example, where the water system is strapped to the user for extended and easier carrying. In this implementation, the cap system with filter can employ a rigid and extended cap system that inserts over and inside the hose to provide more rigid filter system when in use.

The filter can be a cylindrical accordion type filter medium sealed at both ends of the cylinder shape to prevent particulates from escaping into the filtered liquid stream being consumed. The filter can be a multi-accordion filter system with concentric filters (smaller cylindrical accordion filter within a larger cylindrical accordion filter) sealed at both ends of the cylinder(s) such that the water is double (multi-) filtered, for example. In yet other embodiments, the filter can be a cylindrical fan-fold formfactor filter, cylindrical carbon filter (of a single cylindrical formfactor), multiple stacked filter discs, etc.

As disclosed herein in one embodiment, there is described a liquid filtration system, comprising: a filter subsystem for attachment to a container opening of a container holding a liquid, and through which filter subsystem the liquid is filtered and consumed, the filter subsystem comprising: an attachment mechanism which enables attachment of the filter subsystem to the container opening, the attachment mechanism further comprises an internal opening, and an external opening distal from the internal opening, the internal opening enables access of the filter subsystem to the liquid internal to the container, and the external opening enables external access of the filter subsystem for consumption of filtered liquid drawn through the filter subsystem; and a filter secured to the attachment mechanism and through which the liquid is obtained (e.g., drawn) for consumption.

The liquid filtration system filters micro-plastic particulates from the liquid as the liquid is passed (e.g., drawn or pushed) through the filter subsystem. The filter can be at least one of a carbon cylindrical filter which filters micro-plastic particulates from the liquid as the liquid is drawn through the filter subsystem, or a fan-fold cylindrical filter which filters micro-plastic particulates from the liquid as the liquid is drawn through the filter subsystem. The container can be made of flexible plastic as in a plastic bottle, and the liquid can be water.

The attachment mechanism can be designed as compatible with an attachment design (e.g., tightening threads) of an original cover of the container which secures over the container opening. In one implementation, the filter can be of a length which extends into the container opening in a neck portion of the container. In another implementation, the filter is of a length which extends into and through the container opening, and further into a central portion of the container. In still another implementation, the filter can be of a length which extends into and through the container opening, further through a central portion and proximate a bottom of the container.

The liquid filtration system can further comprise at least one of an inner cover installed over the external opening to prevent loss of the liquid when not being drawn through the filter or a travel cover capable of being installed over the external opening and inner cap for secure and leakless storage of the container and liquid. The filter of a given filter subsystem is replaceable. The container and filter subsystem are at least one of disposable or recyclable.

As disclosed herein in another embodiment, there is described a liquid filtration system, comprising: a filter subsystem for attachment to a container opening of a container holding water, and through the filter subsystem which the water is filtered for micro-particulates; and an attachment mechanism which enables secure attachment of the filter subsystem to the container opening, the attachment mechanism further comprises an internal opening and an external opening distal to the internal opening, the internal opening enables access by the filter subsystem to the water in the container, and the external opening enables external access to the filtered water passed (e.g., drawn or pushed) through the filter subsystem for consumption.

The filter subsystem filters at least micro-plastic particulates from the water as the water is passed (e.g., pushed and/or drawn) through the filter subsystem. The filter is at least one of a carbon cylindrical filter or a fan-fold cylindrical filter, which filters micro-particulates from the water as the water is drawn through the filter subsystem. The attachment mechanism is compatible with an attachment design of an original cover of the container, which original cover and container are plastic, and which secures over the container opening.

The filter can be at least one of a length which extends into the container opening in a neck portion of the container, of a length which extends into and through the container opening and further into a central portion of the container, or of a length which extends into and through the container opening and further through a central portion and proximate a bottom of the container.

In yet another embodiment disclosed herein, there is described a liquid filtration system, comprising: a water filtration subsystem which attaches to an opening of a plastic water container, and through which water is filtered for micro-particulates; and a threaded cap attachment mechanism which enables secure attachment of the water filtration subsystem to the opening, the cap attachment mechanism further comprises an internal opening and an external opening distal to the internal opening, the internal opening enables access by the water filter subsystem to the water in the container, and the external opening enables external access to the filtered water passed through the filter subsystem.

The filter subsystem filters micro-plastic particulates from the water as the water is drawn or pushed through the filter subsystem. The attachment mechanism is compatible with an attachment design of an original cover of the container, which original cover and container are plastic, and which secures over the container opening.

In still another embodiment, a liquid filtration system is disclosed, comprising a cartridge subsystem through which water from a bottle opening of a disposable plastic bottle is filtered for micro-particulates, the cartridge subsystem includes a filter cartridge, a first endcap on a first end of the filter cartridge and a second endcap on a second end of the filter cartridge, the second endcap distal to first endcap; a tightening body which secures to the bottle opening, the cartridge subsystem partially extends the filter cartridge and second endcap through the tightening body and into the bottle; and a secondary cover which mounts over the first endcap of the filter cartridge and secures the cartridge subsystem to an external threaded portion of the tightening body, the secondary cover further includes an exit port via which filtered water is passed from the bottle.

In yet another embodiment, there is disclosed a method for filtering at least microplastics from a handheld plastic disposable bottle in accordance with a disclosed embodiment. A micro-particulate filter cartridge is received and sized to fit into at least one of the mouth or the body of the disposable plastic bottle of water. An upper endcap is applied to the cartridge through which filtered water passes, and a lower endcap is applied to the cartridge end distal to the upper endcap, the lower endcap houses a check valve. The upper endcap is secured into a tightening cover. The filter cartridge is tightened to the bottle threads at the mouth via the tightening cover. A secondary cover is secured to the tightening cover. Water is accessed from the bottle via a mouth piece of the tightening cover (e.g., passed (drawn) through the filter by low pressure at the mouth piece or passed (forced) through the filter to the mouth piece by container wall pressure applied by the user).

In an alternative use case, water can be inserted back into the bottle through the cap filtration system while the filtration system is mounted on the bottle. This use case may not filter the water applied in the reverse direction (water external to the bottle, inserted into the bottle through the filtration system), but when subsequently passed back through filtration system in the forward direction (water in bottle and out through the filtration system), the water initially passed through the filter will be filtered, and aid in flushing the residual unfiltered water residing in the core of the filter cartridge.

For example, liquid re-insertion, in reverse, into the container through the filtration system can unseat the lower endcap check valve (employed to unseat and allow air that may have been squeezed out of the container from applied pressure to the container walls by the user, to re-enter the container).

In yet another alternative use case, where the filtration system may be permanently fixed to the container (cannot be removed), the container can be refilled with liquid such as water by using a “refill” tube of a dimension which can enter into the cartridge conduit and unseat the check valve to allow replacement liquid back into the container for filtered consumer use. Use of the tube through which the replacement liquid is inserted bypasses the filter media during the insertion phase, but then employs filtration as usual during the consumption phase when the lower check valve re-seats.

In still another implementation, there is disclosed a liquid filtration system, comprising, a filter subsystem configured to attach to external threads of a container opening of a container holding a consumable liquid, and to pass the liquid therethrough, the filter subsystem comprising: a filter cartridge configured to pass the consumable liquid therethrough, the filter cartridge comprising a top endcap, a bottom endcap, a filter media secured between the top endcap and the bottom endcap, and a central liquid pathway internal to the filter media and which extends between the top endcap and bottom endcap; and, an attachment mechanism comprising a tightening body, the tightening body comprising an annular center with a top opening having external threads and a bottom opening having internal threads, the tightening body configured to receive the bottom endcap of the filter cartridge through the top opening, through the annular center, and through the container opening, and further configured to position the top endcap against the top opening of the annular center.

The attachment mechanism further comprises a secondary cover configured with internal threads and external threads distal to the internal threads, the internal threads of the secondary cover tighten onto the external threads at the top opening of the tightening body to secure the top endcap of the filter cartridge against the top opening of the tightening body; and a draw-through object proximate the external threads of the secondary cover, the draw-through object configured to enable access to the consumable liquid from the filter cartridge.

The internal threads of the tightening body can be configured to tighten directly onto the external threads of the container opening, absent an interstitial connection between the internal threads of the tightening body and the external threads of the container opening. The filter media can be configured as a non-electrically charged media. The filter media is a multilayered media configured to filter micro-particulates from the liquid. The draw-through object can be fabricated as part of the secondary cover, the draw-through object fabricated proximate the external threads of the secondary cover.

The liquid filtration system can further comprise at least one of a top protective cover or a bottom protective cover, the top protective cover configured to secure over a portion of the secondary cover to protect the liquid in the filter subsystem, and the bottom protective cover can be configured to thread onto the external threads of the tightening body cover to protect the filter cartridge from external particulates.

The liquid filtration system can further comprise a riser part (also referred to as an extender part) configured to receive one of multiple different filter cartridges of different lengths, the riser part and received filter cartridge further configured to install proximate the top of the tightening body and proximate the bottom of the secondary cover. The riser part can be configured as part of the attachment mechanism, the riser part of a specified length and configured to accommodate a filter cartridge compatible with the specified length, the riser part further configured to capture the top endcap of the filter cartridge to form a captured filter cartridge, and when installed, the captured filter cartridge extends above the container opening and internally below the container opening. The riser part can be configured to receive a filter cartridge having a bottom endcap, the bottom endcap installed to be positioned proximate a top of the container opening.

The specified length of a first filter cartridge ranges from about one inch to about three inches, the specified length of a second cartridge ranges from about three inches to about six inches, and the specified length of third cartridge ranges from about six inches to about nine inches. The top endcap of the filter cartridge fabricated as a top endcap gasket having a beveled opening, the beveled opening configured to compressively seal against an internal bottom part of the secondary cover, the internal bottom part located above the internal threads of the secondary cover. The bottom endcap can further comprise a valve configured to enable pressure equalization between an internal atmosphere of the container and an external atmosphere of the container.

The liquid filtration system can further comprise a disc filter configured to install between the top endcap and the bottom of the secondary cover to provide additional filtering of the container liquid. The filter subsystem is at least one of replaceable, disposable, or recyclable.

In yet another embodiment, a liquid filtration system is disclosed which comprises a filter subsystem configured to attach to external threads of a container opening of a container holding a consumable liquid, and to pass the liquid therethrough: a filter cartridge configured to pass the consumable liquid therethrough to filter micro-particulates therefrom, the filter cartridge comprising a top endcap, a bottom endcap, a filter media secured between the top endcap and the bottom endcap, and a central liquid pathway internal to the filter media and which extends between the top endcap and bottom endcap.

An attachment mechanism is disclosed as part of the liquid filtration system, the attachment mechanism comprising a tightening body, the tightening body comprising an annular center with a top opening having external threads and a bottom opening having internal threads, the tightening body configured to receive the bottom endcap of the filter cartridge through the top opening, through the annular center, and through the container opening, and further configured to position the top endcap against the top opening of the annular center, the internal threads of the tightening body configured to tighten directly onto the external threads of the container opening and without any interstitial connection between the internal threads of the tightening body and the external threads of the container opening.

The attachment mechanism can further comprise a secondary cover configured with internal threads and external threads distal to the internal threads, the internal threads of the secondary cover tighten onto the external threads at the top opening of the tightening body to secure the top endcap of the filter cartridge against the top opening of the tightening body.

The liquid filtration system can further comprise a draw-through object proximate the external threads of the secondary cover and configured to enable access to the consumable liquid from the filter cartridge, the draw-through object is fabricated as part of the secondary cover and fabricated proximate the external threads of the secondary cover.

The liquid filtration system can comprise a riser part configured to receive one of multiple different filter cartridges of different lengths, the riser part and received filter cartridge further configured to install proximate the top of the tightening body and proximate the bottom of the secondary cover. For example, the riser part can be configured as part of the attachment mechanism, the riser part of a specified length and configured to accommodate a filter cartridge compatible with the specified length, the riser part further configured to capture the top endcap of the filter cartridge to form a captured filter cartridge, when installed, the captured filter cartridge extends above the container opening and internally below the container opening.

The specified length of a first filter cartridge can range from about one inch to about three inches, the specified length of a second cartridge can range from about three inches to about six inches, and the specified length of a third cartridge can range from about six inches to about nine inches.

In still another embodiment, there is disclosed a liquid filtration system, comprising: a filter subsystem configured to attach to external threads of a container opening of a container holding a consumable liquid, and to pass the liquid therethrough, the filter subsystem comprising: a filter cartridge configured to pass the consumable liquid therethrough, the filter cartridge comprising a top endcap, a bottom endcap, a filter media secured between the top endcap and the bottom endcap, and a central liquid pathway internal to the filter media and which extends between the top endcap and bottom endcap; an attachment mechanism comprising a tightening body, the tightening body comprising an annular center with a top opening having external threads and a bottom opening having internal threads, the tightening body configured to receive the bottom endcap of the filter cartridge through the top opening, through the annular center, and through the container opening, and further configured to position the top endcap against the top opening of the annular center, the internal threads of the tightening body are configured to tighten directly onto the external threads of the container opening; the attachment mechanism further comprises a secondary cover configured with internal threads and external threads distal to the internal threads, the internal threads of the secondary cover tighten onto the external threads at the top opening of the tightening body to secure the top endcap of the filter cartridge against the top opening of the tightening body, the top endcap of the filter cartridge fabricated as a top endcap gasket having a beveled opening, the beveled opening configured to compressively seal against an internal bottom part of a secondary cover, the internal bottom part located above the internal threads of the secondary cover; a draw-through object proximate the external threads of the secondary cover, the draw-through object configured to enable access to the consumable liquid from the filter cartridge; and a riser part configured as part of the attachment mechanism, the riser part of a specified length and configured to accommodate a filter cartridge compatible with the specified length, the riser part further configured to capture the top endcap of the filter cartridge to form a captured filter cartridge, when installed internal to the riser part, the length of the captured filter cartridge extends at least one of above the container opening or below the container opening.

At least one of the draw-through object, the riser part, the filter cartridge, or attachment mechanism can be fabricated as a single unit, which single unit can be replaceable and recyclable. The riser part can be configured to receive one of multiple different filter cartridges of different lengths, the riser part and received filter cartridge further configured to install proximate the top of the tightening body and proximate the bottom of the secondary cover. The specified length of a first filter cartridge ranges from about one inch to about three inches, the specified length of a second cartridge ranges from about three inches to about six inches, and the specified length of third cartridge ranges from about six inches to about nine inches. The bottom endcap further comprising a valve configured to enable pressure equalization between internal atmosphere of the container and an external environment of the container. The liquid filtration system can further comprise a disc filter configured to install between the top endcap and the bottom of the secondary cover to provide at least one of filtering or additional filtering of the container liquid.

In yet still another embodiment, there is disclosed an alternative method of filtering microplastics from a handheld plastic disposable bottle. A filter cartridge of a length based on dimensions of a container and container opening, is received. An upper portion length of the filter cartridge to position above the container opening and determining a remaining lower portion length of the filter cartridge to position proximate the container opening, is determined.

A riser part is received which captures an upper endcap at the upper portion of the filter cartridge and encloses the upper portion length of the filter cartridge. A draw-through object is configured as part of the riser part and proximate the upper endcap. The remaining lower portion length of the filter cartridge is inserted through the container opening. A bottom end of the riser part is secured directly to the external threads at the container opening. Micro-particulates can then be filtered from the consumable liquid as the consumable liquid passes through the filter cartridge in response to user action relative to at least one of the container walls or the draw-through object. The method can further comprise extending a lower endcap of the remaining lower portion length of the filter cartridge through the container opening and further into a main body portion of the container.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a cap filtration implementation for a container from which a liquid can be filtered for a desired use, in accordance with the disclosed architecture.

FIG. 2 illustrates an expanded view of a cap filtration system through which the liquid can be drawn and filtered for micro-particulates, in accordance with the disclosed architecture.

FIG. 3 illustrates a cross-sectional view of a cap filtration system, in accordance with the disclosed architecture.

FIG. 4 illustrates a cover system for receiving, handling, and storing new filters before installation in a compatible filtration system.

FIG. 5 illustrates a medium length cover system for handling and storing a medium length filter filtration system before installation in a compatible container for particulate filtration.

FIG. 6 illustrates a system where the medium length filtration system of FIG. 5 is mounted on a container for micro-particulate (plastics) filtering, in accordance with disclosed embodiments.

FIG. 7 illustrates a system where a long-length filtration system is mounted on a container for micro-particulate filtering, in accordance with disclosed embodiments.

FIG. 8 illustrates a system where a still longer-length filtration system is mounted on a container for micro-particulate filtering, in accordance with disclosed embodiments.

FIG. 9 illustrates a comparative view of various cap filter system orientations for a single bottle formfactor, in accordance with disclosed embodiments.

FIG. 10 illustrates a comparative view of various cap filter system orientations for various bottle formfactors of differing heights and volumes, in accordance with disclosed embodiments.

FIG. 11 illustrates alternative techniques for protecting the cap filter system of the disclosed architecture.

FIG. 12 illustrates a conical-shaped port/cover as an alternative cover design to protect a cap filter system.

FIG. 13 illustrates an implementation of an alternative case where the disclosed filtration system can reside for storage, use, and reuse.

FIG. 14 illustrates a view of aspects of the tightening cover of FIG. 13, and an adapter cover design.

FIG. 15 illustrates views of aspects of the top cover of FIG. 13, in one embodiment.

FIG. 16 illustrates views of aspects of the secondary cover of FIG. 13, in one embodiment.

FIG. 17 illustrates different views of the bottom cover of FIG. 13, in one embodiment.

FIG. 18 illustrates different filter cartridge views in accordance with an alternative filter cartridge embodiment.

FIGS. 19A-19D illustrate various views of an alternative filter cartridge assembly which can be employed for filtering particulates from water of disposable handheld liquid bottles, in accordance with a disclosed embodiment.

FIG. 20 illustrates an implementation of an alternative case/filter assembly where the disclosed filtration system can reside for shipping, storage, installation, use, and discard.

FIG. 21 illustrates an alternative filter embodiment which includes a flavor module for implementation with a larger cover container, in accordance with an alternative embodiment.

FIG. 22 illustrates yet another alternative implementation where the disclosed filtration system can be employed.

FIG. 23 illustrates a method of filtering microplastics from a handheld plastic disposable bottle in accordance with a disclosed embodiment.

FIG. 24 illustrates an alternative method of filtering microplastics from a handheld plastic disposable bottle in accordance with a disclosed embodiment.

### DETAILED DESCRIPTION

Described herein is a “cap” (or cap-based) liquid filtration system (e.g., machined, molded device, etc.), which can be designed and fabricated as a single unit (e.g., replaceable, reusable, single-use, etc.) comprising the capability of replacing the standard bottle cap of the container utilized, and typically provided by vendor processes, and then filtering particulates (e.g., at least micro-plastics) from water of a disposable plastic bottle while the water is drawn from the bottle. Alternatively, the filtration system can be designed as a system of two or more combined and/or separate components (e.g., filter cartridge and filter cartridge capture mechanism are a single unit, bottle attachment mechanism as a single unit, etc.), a riser part (also, extender part), the filter cartridge and filter capture mechanism as a single unit, etc.). The filtration system can employ at least one filter, and/or two or more filters simultaneously for different purposes. For example, “puck” (pliable or non-pliable disk-shaped) filters of suitable dimensions and differing particulate filtering capabilities can be employed, such as a single puck filter, two stacked puck filters (each filter used for a different particulate filtering purpose), or more. Moreover, such “puck” filters can be applied to one end, or filters utilized to both ends of the filter cartridge endcaps for filtering.

The liquid filtration system can be attached to any manufactured bottle (e.g., plastic, metal, etc.) by external connection to the bottle mouth (e.g., by threaded capture using threads at the bottle mouth/neck, by a compression fitted mounting system which compresses down on the external surface of the bottle mouth, bottle neck, etc.), attaches to the features of the bottle neck (e.g., threads, neck ring, etc.), and/or internal connection to neck of the bottle (e.g., internal compression fitting pressing outwardly from inside the mouth, neck, etc.). Accordingly, the disclosed cap filtration system can be designed for any formfactor of liquid container opening(s), caps or cover(s).

The installed liquid filtration system, now functioning also as a cap to the bottle, replaces the original manufacturers cap to assure the user that the water being consumed from the bottle is free of micro-particulates such as micro-plastics or other contaminants introduced into the bottle during the manufacturing process and/or during post-manufacture use.

The liquid filtration system can be purchased separately by the user and attached to the bottled water provided by the vendor, and for use when consuming the bottle contents. Additionally, in one embodiment, the bottled water vendor can provide and cap each unit of bottled water with an individual and installed filtration system (already installed on the bottle), or uninstalled with the bottled water but provided for the user to then install before use.

Alternatively, the filtration system can be sold separately as a single unit or a pack of multiple units which can be installed on the bottle of water by the user. Thereafter, the user can remove the prior-used filtration unit from the bottle, refill the bottle with fresh water, reattach to the bottle a new un-used filtration unit, and thereafter, consume the fresh water now filtered free of micro-particulates.

Accordingly, the features disclosed and claimed herein, without limitation, comprise: a fabricated (e.g., machined, molded, etc.) cap-based filtration system that attaches to disposable plastic bottles of water; a fabricated (e.g., machined, molded, etc.) cap-based filtration system that comprises a filter sufficient to remove micro-plastics from the contained water; a fabricated (e.g., machined, molded, etc.) cap-based filtration system that is replaceable; a fabricated (e.g., machined, molded, etc.) cap-based filtration system that can be opened to access the filter; a fabricated (e.g., machined, molded, etc.) cap-based filtration system that can be closed to secure the filter in place for use; a fabricated (e.g., machined, molded, etc.) cap-based filtration system fitted and secured into the neck of the bottle; a fabricated (e.g., machined, molded, etc.) cap-based filtration system containing a replaceable filter that is fitted into the neck of the plastic bottle; and a fabricated (e.g., machined, molded, etc.) cap-based filtration system which prevents water from leaking from of the bottle via the filtration system when the water is not purposely drawn from the bottle.

Filtration is in widespread use to clean liquids (e.g., water) and gasses (e.g., breathable, etc.) for many purposes. The different filtration methods work by the use of membranes of varying pore sizes to achieve the filtration results for the desired purpose. For example, micro-filtration (micron-sized particles) is achieved using one or more membranes having pore sizes ranging from 0.1 micrometer (μm) to 10 μm. As a liquid such as water passes through the micro-filtration membrane pores, particulates (also termed, “substances”) equal to and larger than 0.1 μm are trapped in the membrane pores. In another degree of filtration, ultra-filtration filters trap substances equal to or larger than 0.01 μm to 0.1 μm. In yet another degree of filtration, nano-filtration filters trap substances equal to or larger than 0.001 μm to 0.01 μm. Accordingly, the various filtration techniques can be utilized herein for the desired application and results.

In use, the original bottle (e.g., plastic) of liquid (e.g., water) is typically made available to the user with a manufacturer cap installed during the factory bottling (e.g., liquid insertion) or bottle fabrication process. Thereafter, the user removes the manufacturer cap at the bottle opening and then installs the disclosed cap filtration system on the bottle opening. More specifically, the cap filtration system is affixed at or near the now uncapped bottle opening, affixed externally to the neck of the bottle (e.g., via bottle threads used by the prior cap), affixed to the inside of the bottle neck (e.g., outward pressure against the inside of the mouth of the bottle), or according to other suitable techniques for affixing the cap filtration system.

The cap filtration system is capable of utilizing removable micro-particulate cartridge filters of various lengths and dimensions. Accordingly, the user can replace the micro-particulate filter of a cap filtration system, and then close/secure the cap filtration system for continued use. The contents of the bottle are now ready for consumption with no harmful effects, since the disclosed filtration system removes micro-particulates (e.g., plastics) from the liquid.

The cap filtration system can be manufactured to function as a single-use bottle filtration system or multiple-use bottle (or bottles) filtration uses. Thus, the bottler (manufacturer) can package and sell the cap filtration system with each bottle of liquid sold, as a separate item to be installed by the user, as an already-installed filtration system on the bottle, or both. Moreover, the bulk purchaser can order quantities of bottle-cap filtration systems with specific filter dimensions for bottles of different volumes/sizes. For example, bottles of larger volumes (and length-height) can be fitted and sold with cap filtration systems suitable for the given container bottle/container dimensions, opening dimensions, etc.

Additionally, the cap system is designed to employ a variety of replacement filters. Thus, it is within contemplation that the disclosed architecture is capable of receiving and utilizing filter cartridges with the filtering capability to remove even smaller particulates such as nano-particles.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in diagram form in order to facilitate a description thereof. The intention is to cover all modifications, equivalents, and alternatives falling within the spirit and scope of the claimed subject matter.

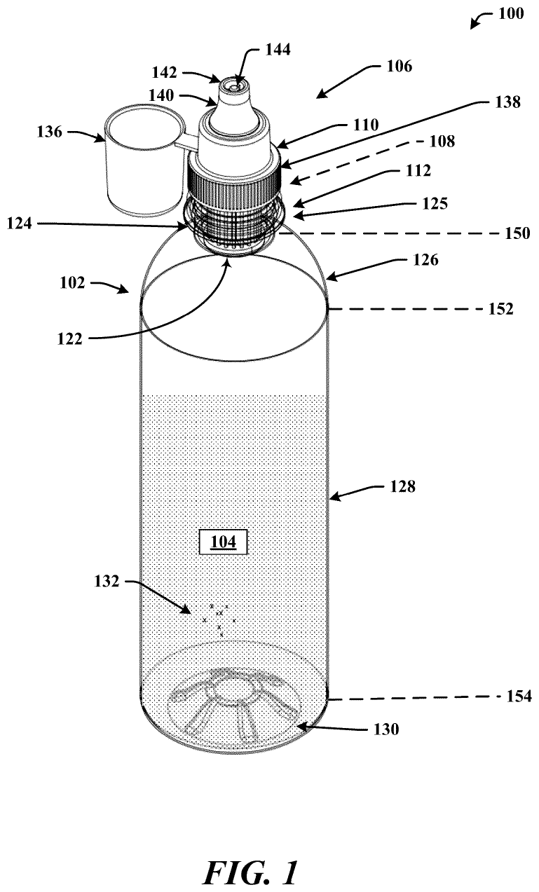

FIG. 1 illustrates a “cap” (implies, “cap-installed”) liquid filtration implementation 100 (also referred to as a “cap-based” filtration implementation 100) since the implementation 100 installs a liquid filtration system 106 directly to threads 112 at container opening 108 (also, mouth 108) of a container 102, where a production cap is normally installed during production packaging, or removed by the user during normal use without a liquid filtering capability.

Alternatively, the filtration implementation(s) 100 described throughout this description can alternatively employ a snap-on or clamp-on “compression” capture mechanism where the entire filtration implementation 100 can employ such technology to simply force compression capture of the liquid filtration system 106 onto the threads 112 such that the capture mechanism firmly secures the liquid filtration system 106 to the container opening 108 without requiring threading onto the threads 112 at the opening 108.

Such compression implementation(s) ensures securement of the liquid filtration system 106 to the container 102 and container opening 108 such that no container liquid 104 leaks around the implementation 100 during use or various orientations of the container and/or liquid/filtration assembly 106 when used or not used. This “capture” feature finds applicability to all containers described herein.

For the container 102 (e.g., plastic, food-grade plastic, glass, metal, flexible pouch, etc.) from which the liquid 104 (e.g., water) can be filtered for microplastics for a desired use (e.g., direct consumption, food preparation, etc.), the implementation 100 depicts the container 102 on which the liquid filtration system 106 can be employed.

The container 102 is typically fabricated with an opening (or mouth) 108 (blocked from view under an installed liquid filtration system 106, but identified with a dashed line/arrow to indicate presence of the mouth 108). The mouth 108 is the opening of the container 102 through which the liquid 104 is inserted during a “bottling operation” production, and through which the liquid 104 can be drawn out (by reduced pressure applied by the user imposing a vacuum) at the opening or pushed out from the container 102 (by the user applying compression to the container (e.g., sides)) to be consumed, used, etc., with or without the filtration system 106.

As previously indicated, the liquid filtration system 106 comprises a retainer (or attachment) functionality which secures the filtration system 106 to the threads 112 at the container mouth 108. The filtration system 106 can be fabricated as a single unit comprising a foldable protective cover 136 (also referred to as a flip-over cover) attached to a threaded tightening body (or cover) 138 for tightening down (also “attachment”) of the filtration system 106 to the mouth 108 of the container 102. The attachment functionality is described in greater detail herein.

As shown, the container 102 is typically fabricated to comprise the threaded mouth 108 on which a vendor-supplied cover (not shown) is typically attached (fixed) after filling the container 102 with the liquid (e.g., water), thereby making the product ready for shipping and/or handling in vending machines, store sales, etc.

Accordingly, the consumer can purchase the implementation 100 as depicted, with the filtration system 106 already attached to the container mouth 108. Alternatively, the consumer can obtain the container 102 fabricated with the standard plastic cap (“production cap”) captured over (threaded onto) the mouth 108 after the container 102 is filled with the liquid 104. Thereafter, the consumer can remove the production cap and install the filtration system 106 to the container mouth 108 to then obtain filtered water therefrom (e.g., free of micro-plastics) as desired.

As described, filtration system 106 can comprise a filter cartridge subsystem 122 which filters particulates 132 (e.g., at least micro-particulates such a plastics) from the liquid 104 in the container 102 as the liquid 104 passes through the filtration system 106.

The container 102 can be a typical liquid container constructed of materials such as food-grade plastics, metal, non-food grade plastics, woven fabrics/fibers such as nylon, etc., sufficient (e.g., in structure and strength to hold form and anti-leakage) to hold the liquid 104 and to be handheld and/or carried by a user, and which is typically designed to stand in an upright position, although this is not a requirement for use of the disclosed liquid filtration system 106.

The disclosed embodiments can be applied to numerous types of plastic bottles (also, containers 102) fabricated to hold consumable liquids, where suitable bottle designs typically include features such as the container mouth (or container opening) 108, a predetermined number of threads 112 (e.g., 2-4, etc.) fabricated externally down the neck portion 125 (defined from the mouth 108 to a neck ring 124 (defined as located underneath and proximate to the bottom of the threaded portion), a shoulder portion 126 (defined as the portion between the neck ring 124 and the vertical sidewall surface of the container 102, a main body (or central) portion 128, and a base portion (or bottom) 130.

More specifically, each of these (portions) sections of the numerous manufactured plastic containers can be delineated by demarcation points, where, for example, a neck-shoulder demarcation point 150 indicates approximately where the bottom of the neck portion 125 ends and the top of the shoulder portion 126 begins; shoulder portion-main body portion demarcation point 152 indicates approximately where the bottom of the shoulder portion 126 ends and the top of the main body portion 128 begins; and, a main body portion-base portion demarcation point 154 indicates approximately where main body portion 128 ends (e.g., between demarcation points 152 and 154), and the base portion 130 begins (between demarcation point 154) and the bottom of the container ends.

The container 102 and filtration system 106, combination, can be a single-use recyclable system. Thus, this combination can be manufactured and sold as a single, filtered-installed system, which is then recyclable. Alternatively, the user can purchase the filtration system 106 separately to be then used with one or more other compatible containers 102, after which one or more filtering uses, the container(s) can be discarded (e.g., recycled) as well as the filtration system 106.

In still another alternative, as described herein, the filter (cartridge) 122 of the filtration system 106 can be replaced with the same filter type, or longer filter types (which extend deeper into the container 102) can be secured according to the designed retainer capability of the filtration system 106.

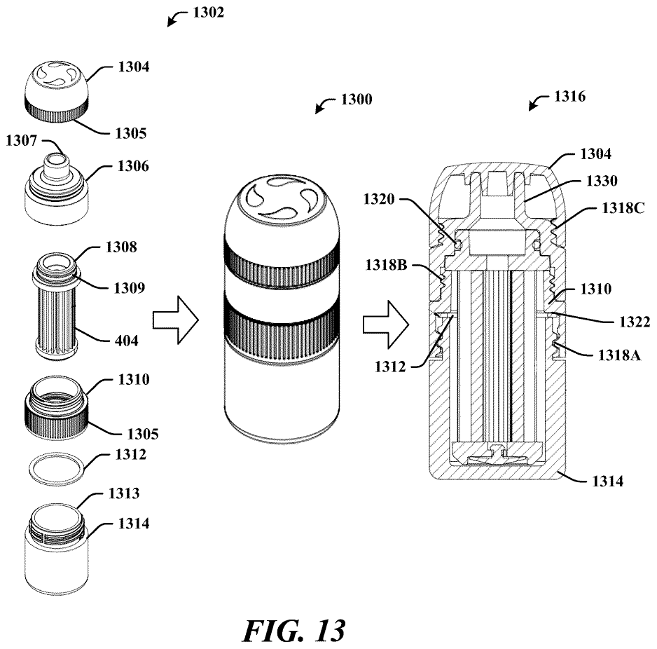

The filtration system 106 can also include a draw-through object 140 (or secondary cover 140, as in FIG. 13) which includes a mouth piece end (also, “nipple”) 142 from which to draw the (filtered) liquid from the container 102, by providing to the user a conical shape that accommodates a wide variety of mouth sizes which assist users in making a sufficient oral contact to consume or access the liquid 104 from the container 102 and through the filtration system 106.

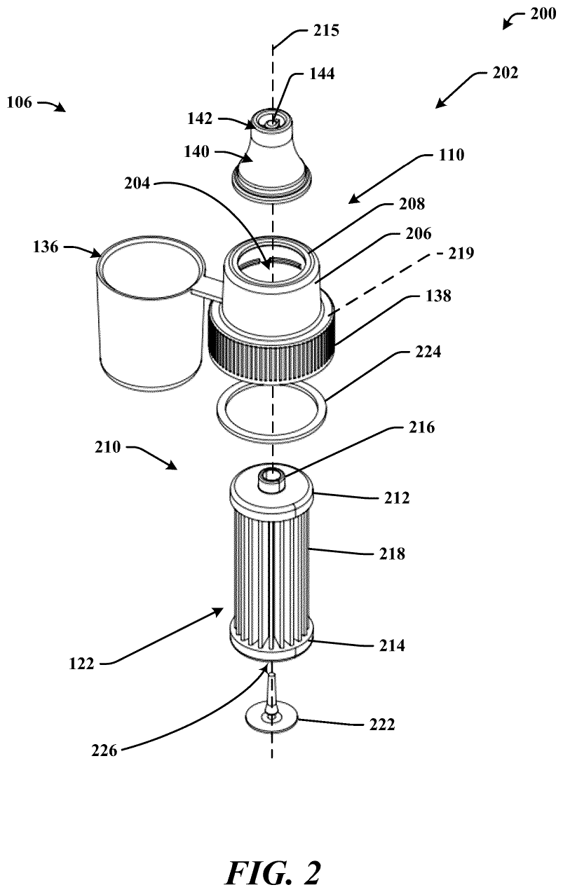

The draw-through object 140 can also house an optional check-valve 144, which check valve 144 functions to keep the liquid 104 inside the container (and possibly, the already-filtered liquid inside the filter 122 and/or filter conduit 216 (of FIG. 2)) until such time as the user initiates another consumption process which causes liquid to pass through the liquid filtration system and out the mouth piece 142 (e.g., draw-down pressure applied to mouth piece 142 enables liquid to pass through/around the check-valve 144 and exit the mouth piece 142).

The attachment mechanism in FIG. 1 comprises the one or more components utilized to attach the overall liquid filtration system 106 to the container 102 and ensure filtered liquid from the container 102. Accordingly, in this implementation, the attachment mechanism comprises components utilized to access and filter the liquid contained in the container 102 such as the threaded tightening body 138, which securely anchors (e.g., threads, clamps-to, snaps-to, etc.) the filtration system 106 capability to the mouth 108 of the container 102. The attachment mechanism further includes the filter subsystem, which includes the filter cartridge having filter media, endcap ports (e.g., and top endcap having an open port, the bottom endcap having the closed endcap port (with check valve) and, and potentially one or more seals, gaskets, etc., to ensure prevention of liquid leaks while in use. The attachment mechanism can also comprise the draw-through object 140 and the cover 136 captured to the container opening 108 by the threaded tightening body 138.

FIG. 2 illustrates an expanded view 200 of a (cap) filtration system 202 (similar to filtration system 106 of FIG. 1) through which the liquid 104 can be caused to pass through and be filtered for at least micro-particulates. Description of the filtration system 202 can generally comprise some or all components of the cap filtration system 106 (also referred to herein as liquid filtration system 110) which enables a secure attachment to, and leakage prevention of the liquid 104 via the components of the filtration system 202 when secured to the container 102.

In this embodiment, the filtration system 106 combines an annular riser part 206 forming an annular region 204, and which riser part 206 may be part of the (flip-over) cover 136, and/or part of the threaded tightening body (or cover) 138, and the foldable protective cover 136, into the single fabricated unit. Here, the filtration system 106 can be tightened down to threads at the container mouth (e.g., mouth 108).

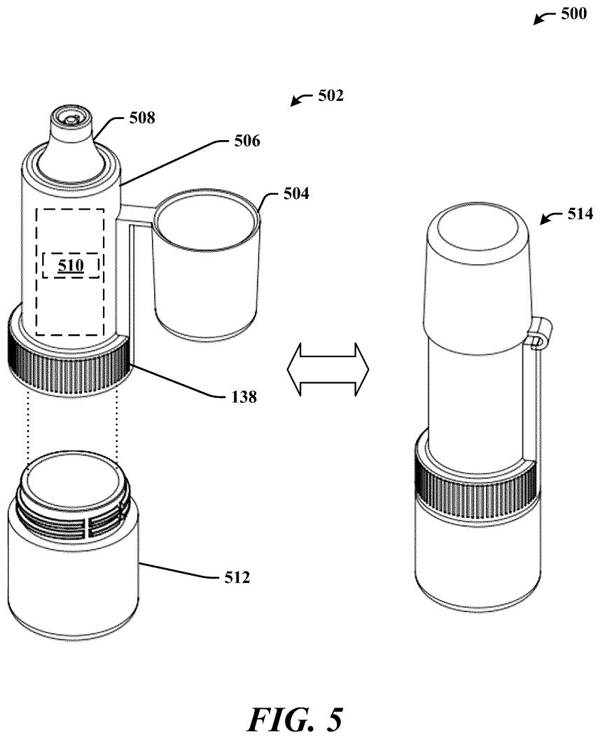

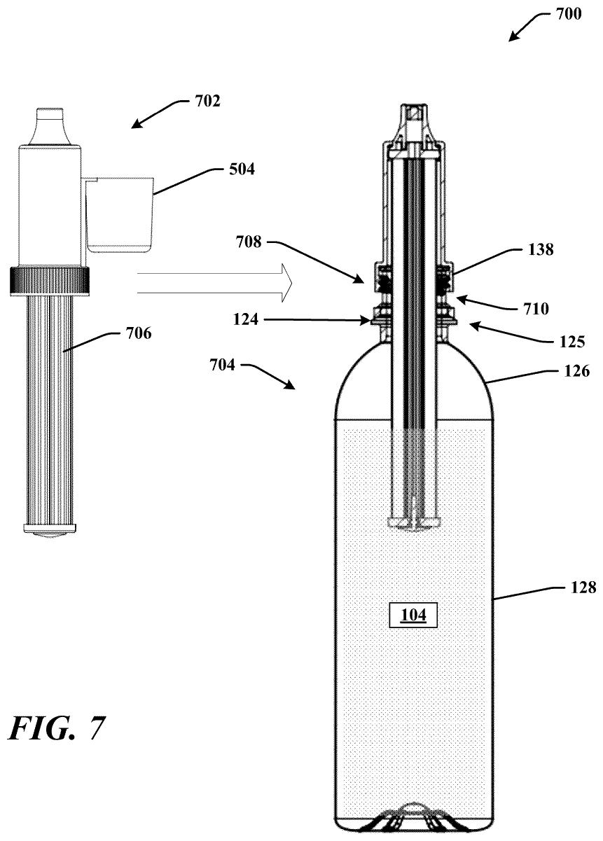

The filtration system 202 can include one or more of the components described in combination with filtration system 106 (also referred to as the filtration system 110), such as for example, the draw-through object 140 which includes an open end at mouth piece 142 from which to draw, for example, the (filtered) liquid 104 from the container 102. The draw-through object 140 can optionally, also house the check-valve 144, which check valve 144 functions to keep the liquid 104 inside the container (and possibly, the filter 122) until such time as the user causes liquid from the container to pass through filtration system(s) the (e.g., draw-down pressure applied to mouth piece end 142 enables liquid 104 to pass through/around the check-valve 144 and exit the mouth piece end 142. In one implementation, the draw-through object 140 and riser part 206 can be fabricated as a single piece, as shown in FIG. 5 and FIG. 7, for example.

Turning to the filter subsystem 210 (the combined particulate filter cartridge 122, a top endcap 212, a bottom endcap 214 (distal from the top endcap 212), and a filtered liquid pathway (or conduit) 216 centered on a center longitudinal axis 215 of the cylindrical shape of the cartridge 122, and via which liquid migrates inward (as enabled by the user via, for example, suction by the user or compression of the container walls) through the filter media (or pores) accumulates as filtered liquid in the filtered liquid pathway 216 which passes therethrough and out of the container 102 via the liquid filtration system.

The filter media can be a multi-layered implementation (e.g., triple layers) to ensure support structure and filtering capabilities as desired. For example, in one implementation, filter media can be a fanfold filter configuration of three layers. The filter pleat count can be twenty (20); the filter media material can be a three-layer laminate comprising an exterior layer, an interior layer, and a middle layer “sandwiched” between the exterior and interior layers, where the exterior and interior layers can be CCPET040 spun-bound polyester filter media trilobal; middle layer can be CCPA1.2 single layer or double (“folded-over”) layer, a nylon microfiltration membrane with a 1.2 micron rating. The endcaps can be fabricated using a polycarbonate; the filter potting material affixes each filter end to a respective endcap, can be HM302 food safe hot melt adhesive free of dust, debris, and contaminants.

The top endcap 212, bottom endcap 214, and central filter pathway 216 provide a rigid structure sufficient to retain the formfactor of a filter medium 218 (e.g. fanfold, flat sheet, and other filter media configurations, etc.) for use in flexible-walled containers (e.g., plastic) and stiff-walled containers (e.g., metal) and for insertion, removal, and/or replacement of the filter cartridge 122.

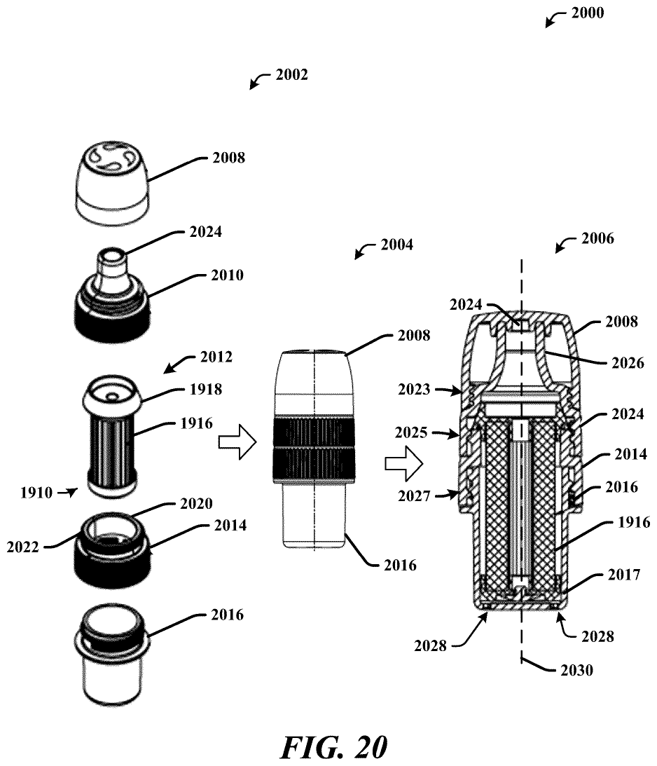

The top endcap 212 engages (seats against) the width portion near the perimeter of gasket 224 (but can be optional, e.g., in the assembly 2000 of FIG. 20) to force the gasket 224 against an interior upper lip 219 (denoted using the dashed line tag to indicate not viewable from this angle) of the outwardly-facing grip section of the threaded tightening body (or cover) 138. This force generates a seal between the upper inside lip 219 of the grip section 138 and the top endcap 212 of the filter cartridge 122 such that no particulates escape or bypass the filter cartridge 122 and enter the liquid 104 and or the user in the central filter pathway 216 being drawn out from the container 102.

The filter subsystem 210 can also include a check valve 222 (also referred to as an “umbrella” check valve) inserted into a distal pathway end 226 located at the distal end 214 of the filter cartridge 122, which check valve 222 enables flow control of the liquid 104 being drawn into the filter cartridge 122 from the container 102, but not into the pathway end 226 of the bottom endcap 214.

The annular riser part 206 also supports the capture of the draw-through object 140 which protrudes through and is captured by an overlying rim 208 of the annular region 204 defined by riser part 206. Object 140 is secured outward and away from the container mouth 108. The threaded tightening body 138 enables stabilization of the filtration system 210 relative to orientation of the filter cartridge 122 through the mouth 108 and into the container 102.

The cap filtration system 106 is also shown with the protective cover 136, attachable as a fold-over accessory which can be locked (closed) down onto and captured by the annular riser part 206 to prohibit unwanted materials/particulates from entering back into part(s) of the filtration system 106. The draw-through object 140, rather than a separate component, can be fabricated as part of the cover 206, thereby as one contiguous component.

Following is description that depicts additional capabilities of the disclosed liquid filtration architecture. What is described are various filter implementations where filter cartridges of different lengths can be employed for corresponding containers of different heights/depths. Additionally, such filters can be attached and made operational such that the top endcap of the filter is positioned and secured above the top of the container mouth 108.

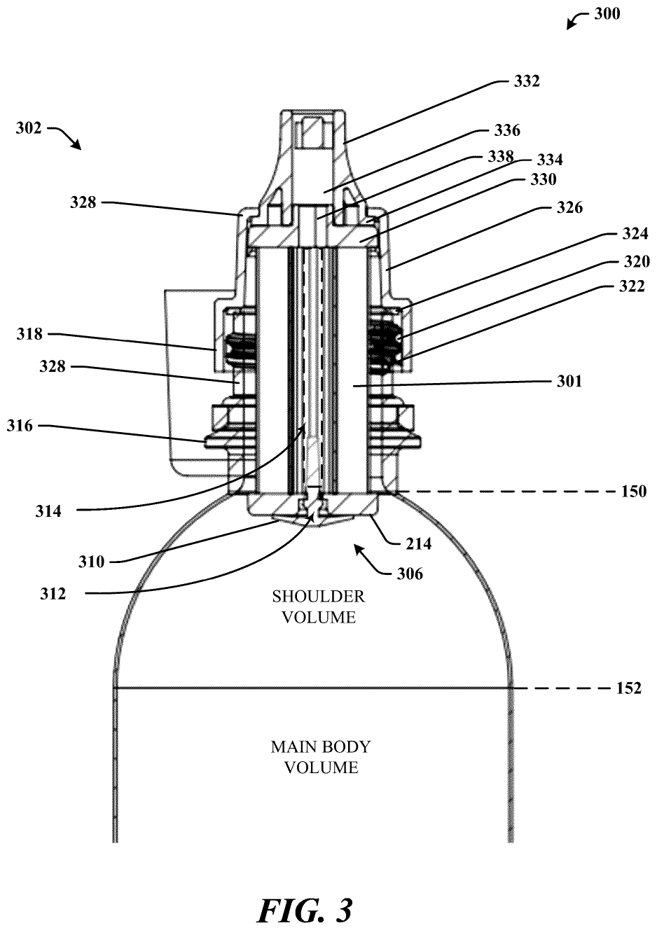

FIG. 3 illustrates a cross-sectional view 300 of a filtration system 302 in accordance with the disclosed architecture. This particular view 300 applies to a short version of a filter cartridge 301 (similar to filter (cartridge) 122) of FIG. 1 and FIG. 2. This short length filter version limits filter cartridge length so the bottom endcap 214 at the distal end 306 extends no further than demarcation point 152, defined as where the lower edge of the container shoulder volume 126 ends and the upper edge of the container main body volume 128 begins. Liquid flow occurs past the lower endcap and upwards along the external side of the filter media, to pass radially inward during the filtering process, and then upwards in the center filter conduit (or pathway) 314 to the draw-through object for access by the user. As depicted, the bulk of the short length version filter 301 extends predominantly above the demarcation point 150, except for the bottom endcap 214 at the distal end 306, which is at or below the demarcation point 150.

Other filter cartridges can be utilized that extend beyond the demarcation points (e.g., 150 and 152) about halfway into the main body volume, and another cartridge model that can extend nearly to the container bottom (similar to container bottom 130 of FIG. 1).

In this view 300, a check valve 310 is shown in the bottom pathway orifice 312 of the liquid pathway filtered (dashed line box) and (similar to pathway 216 of FIG. 2). A bottle neck ring 316 is shown (similar to neck ring 124 of FIG. 1). An outwardly-facing grip section 318 is shown comprising interior threads 320 compatible with the exterior threads 322 of the container mouth (similar to threads 112 of FIG. 1). A gasket 324 (similar to gasket 224 of FIG. 2) seals the interface between a cap system 326 (similar to cap filtration system 106 of FIG. 2) and container mouth 328. A top (upper end) endcap 330 of the filter is seated against a draw-through object 332 (similar to object 140 of FIG. 1). The draw-through object 332 has a lip 334 captured between the top endcap 330 of the filter cartridge and an outer shell 328 of the cap system 326 (similar to cap filtration system 110 of FIG. 2).

The draw-through object 332 also comprises an internal interior filter coupler 336 capable of receiving and/or interfacing to a top cap pathway orifice 338 (similar to pathway (orifice) 216 of FIG. 2). Although described that the draw-through object 332 may also include a check valve, this is neither a requirement nor a limitation, since the check valve 310 can serve the same function, and two check valves can be an alternative embodiment.

In this specific arrangement, the filtration system 302 mounts above the demarcation point 150 at the top of the container 102 such that only the distal endcap 214 at the distal end 306 of the filter cartridge 301 is at or below the demarcation point 150, such as mounted when using a short length filter cartridge.

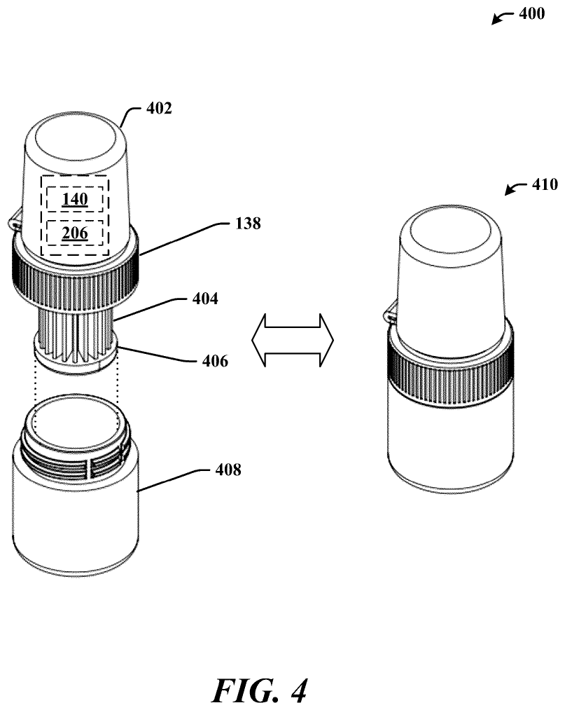

FIG. 4 illustrates a cover system 400 for receiving, handling, and storing new filters before installation in a compatible filtration system. The system 400 enables quantity purchases for use by the buyer. For example, the user can choose to have a fixed number of systems 400 shipped on a regular basis (e.g., monthly) to replace cap-based filter systems determined to be replaced. In other embodiments, the filtration systems can be fixed to the bottle container at the manufacturer, and discarded with the bottle or container at a later time.

The system 400 comprises a short length flip-over cover (or cap) 402 that folds over the combination of the annular riser part 206 and draw-through object 140 (both denoted with dashed line tags as not visible), for a short length filter cartridge 404. The cover 402 abuts against the top of and is captured to, the top of the threaded tightening body 138.

The assembled combination of flip-over cover 402, filter cartridge 404, and bottom cover 408 can be packaged as a single unit, and then sold separately, to replace an existing in-place filter assembly of a plastic bottle, the usable lifetime of at least one of the bottle or the filter assembly which has expired or needs replacement.

When assembled, a bottom portion 406 of the short length filter cartridge 404 is lowered into a bottom cover 408, where ultimately the bottom cover 408 threads into the threaded tightening body 138 to secure and protect the filter cartridge 404 and associated filter features for transport, as shown as a final arrangement 410.

FIG. 5 illustrates a medium length cover system 500 for handling and storing a medium length filtration system 502 before installation in a compatible container for micro-particulate filtration. The medium length cover system 500 comprises a medium length flip-over cover 504 (of the same dimensions as the flip-over cover 402, or longer than the length dimension of flip-over cover 402 to accommodate longer filter cartridges) that folds over annular riser part 506 and draw-through object 508 for a medium length filter cartridge 510 (not visible, but longer than the short length filter cartridge 404).

When assembling, a bottom portion of the medium length filter cartridge 508 (already captured in the riser part 506) is lowered into a bottom cover 512, where ultimately the bottom cover 512 threads into the threaded tightening body 138 to secure and protect the medium length filter cartridge 510 and associated filter features for handling and transport, as shown as a final flip-over cover system arrangement 514.

Here, the riser part 506 and the draw-through object can be utilized as separate individual parts, or fabricated as a single unit which includes both the riser part and the draw-though object. Similarly, the single unit can further be fabricated in combination with the tightening body 138 with the

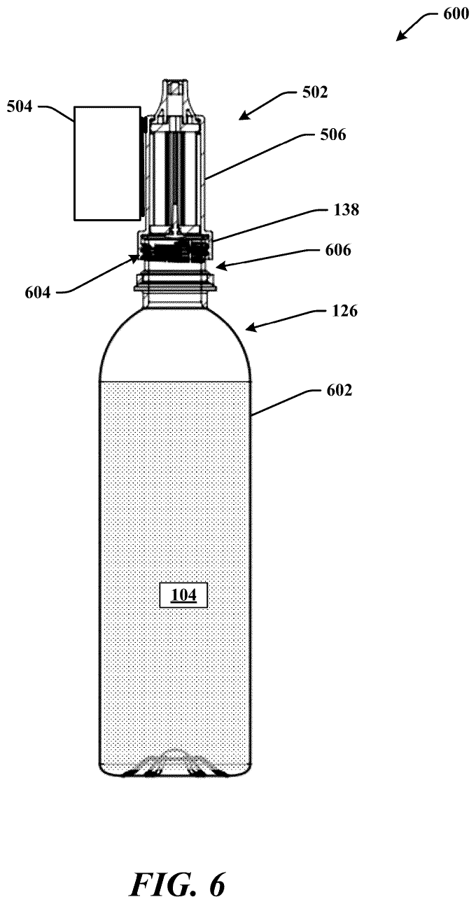

FIG. 6 illustrates a system 600 where the medium length filtration system 502 of FIG. 5 is mounted on a container 602 for micro-particulate (plastics) filtering in accordance with disclosed embodiments. The container 602 can be a flexible plastic-walled container (e.g., a plastic water bottle) or a non-flexible sturdy walled container (e.g., metal, hard plastic, glass, etc.). In this implementation, the filtration system 502 (but not the lower cover 512 of FIG. 5) is threaded onto the container threads 604 on the container neck 606 using the threaded tightening body 138. The flip-over cover 504 can then be flipped away from the riser part 506 such that the liquid 104 can be drawn from the container 602 through the filtration system 502.

In this particular implementation, the filtration system 502 is of such a size that no part of the filtration system 502 extends into the shoulder portion 126 (which is below the neck portion 125 of FIG. 1). A smaller (shorter) filtration system finds application to smaller plastic containers such as six-ounce bottles, etc.

FIG. 7 illustrates a system 700 where a long length filtration system 702 is mounted on a container 704 for micro-particulate (plastics) filtering in accordance with disclosed embodiments. In this implementation, the filtration system 702 comprises a long length filter cartridge 706 (but not the lower cover, e.g., the lower cover 512 of FIG. 5) which is threaded onto the threads 708 on the container neck 710 using the threaded tightening body 138. The flip-over cover 504 can then be moved such that the liquid can be drawn from the container 704 and through the filtration system 702 to filter out micro-plastics.

In this particular implementation, the filtration system 702 is of such a size that the filter cartridge 706 is of a length (“long”) sufficient to extend the cartridge 706 past the neck ring 124, through the neck portion 125, through the shoulder portion 126 (which is below the neck portion 125) and into the main body portion 128. Such a large filtration system 702 finds application to larger (and longer) plastic containers, and where the liquid can be obtained in a greater amount from the container 704 than shorter containers which can be accommodated by the short version filtration system 302, and/or the medium length filtration system 502. Such longer filter cartridges increase the filter media surface area for greater filtering output capability at a faster pace (e.g., for users in accelerated physical exertions, rather than shorter length cartridges for lower energy exertions), but which find applicability to many different container implementations. In this use case, the filtration system 702 extends above the neck ring 124 (approximately) an equal distance that the filter cartridge 706 extends below the neck ring 124 and into the container 128.

As described herein, the different length filter cartridges which can be employed may be positioned and secured above and/or below the container opening at according to ratios of the length-above to the length-below, relative to the container opening, for example. However, the ratio value may not be a significant consideration for normal uses such as walking/strolling rather than increased energy situations (e.g., running, hill climbing, skiing, etc.) where the user desires a greater amount of filtered liquid to consume.

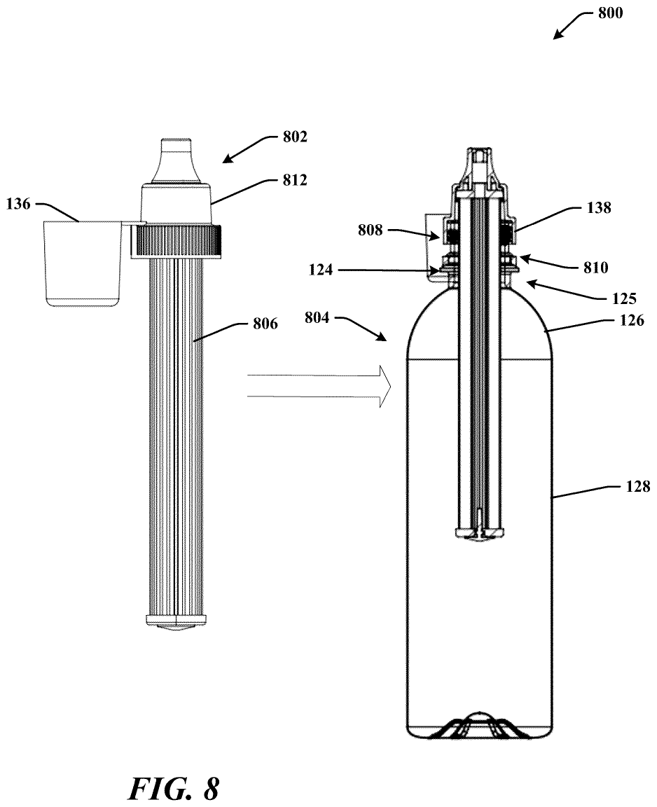

FIG. 8 illustrates a system 800 where a still longer length filtration system 802 is mounted on a container 804 for micro-particulate (plastics) filtering in accordance with disclosed embodiments. In this implementation, the filtration system 802 comprises the longest length filter cartridge 806 (but not the lower cover, e.g., the lower cover 512 of FIG. 5) which is threaded onto the manufactured threads 808 of the container neck 810 using the threaded tightening body 138. The flip-over cover 136 can then be moved such that the liquid can be drawn from the container 804 and through the filtration system 802 to filter out micro-plastics, for example.

In this particular implementation, the filtration system 802 is of such a size that the filter cartridge 806 is of a length (“longest”) sufficient to extend the cartridge 806 through the neck portion 125, through the shoulder portion 126 (which is below the neck portion 125) and into the main body portion 128.

The larger filtration system 802 finds application to equally larger (and longer) plastic containers, and where the user draws a greater amount of liquid from the container 804 than shorter containers which can be accommodated by the short version filtration system 302, and/or the medium length filtration system 502.

Additionally, the filtration system 802 extends about one-fourth of the overall cartridge length above the neck ring 124 (approximately) and about three-fourths of the overall cartridge length below the neck ring 124 and into the container 128.

It can be the instance where the filter cartridge 706 of FIG. 7 and the cartridge 806 of FIG. 8 are identical, but the installed elevations are different. Since the cartridge 706 is installed with a longer riser part 506 than the riser part 810, the overall vertical offset comparison elevates the cartridge 706 higher than the in-situ elevation of cartridge 806.

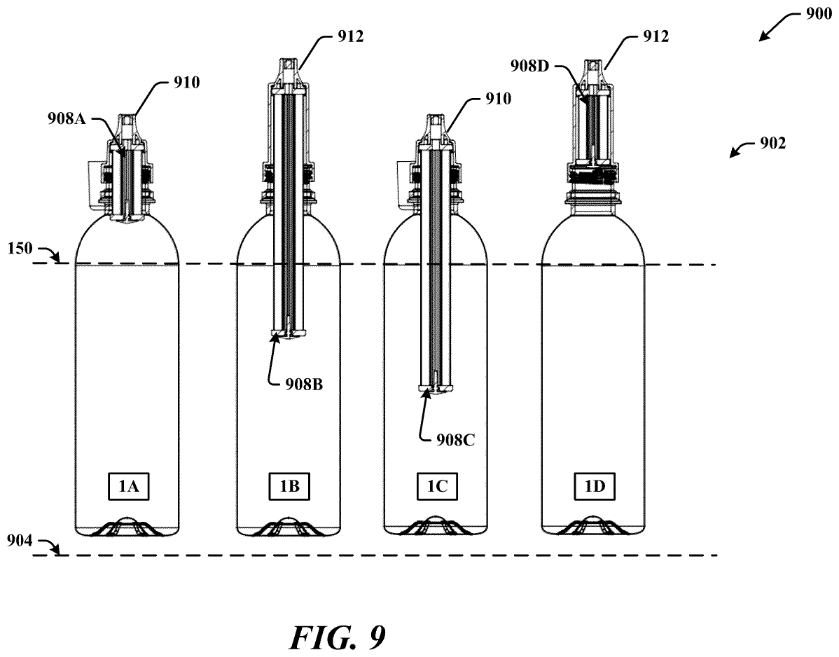

FIG. 9 illustrates a comparative view 900 of various cap filter system orientations for a single bottle formfactor in accordance with disclosed embodiments. As illustrated, the disclosed architecture can be provided with various cap system lengths and various filter cartridge lengths for each of the cap system lengths.

Using a single bottle size 902 across the various implementations, the various filter lengths can be addressed relative to the bottle neck-shoulder demarcation point 150. Shown as aligned relative to a flat surface (represented by dashed line 904), each of the same bottle size (bottles 1A, 1B, 1C, and 1D) indicates the same neck-shoulder demarcation point 150 (represented as a dashed line across the bottles).

This specific view 900 represents two short filter cartridges (cartridge 908A on bottle 1A and cartridge 908D on bottle 1D) and two relatively longer filter cartridges (cartridge 908B on bottle 1B and cartridge 908C on bottle 1C). This view 900 also shows two different sizes of the cap systems: the same sized (length) cap system 910 on bottle 1A and bottle 1C, and the same sized cap systems 912 on bottle 1B and bottle 1D. The cap systems 912 can be referred to as elongated cap systems 912 relative to the smaller (shorter) cap systems 910. Accordingly, FIG. 9 clearly indicates that the cap systems (elongated 912 versus shorter 910) and cartridges sizes (longer cartridges 908B and 908C and shorter cartridges 908A and 908D) can be mixed and matched between the same bottle size, or different bottle sizes.

It can be noticed as well, that when comparing cap system 910 and elongated cap system 912, although using the same length cartridges 908A and 908D, using the elongated cap system 912 elevates the same length filter cartridge 908D higher in the mouth of bottle 1D than the same length filter cartridge 908A in the mouth of bottle 1A, such that relatively, the cartridge 908A is lower in the bottle mouth of bottle 1A, than cartridge 908D is in the mouth of bottle 1D.

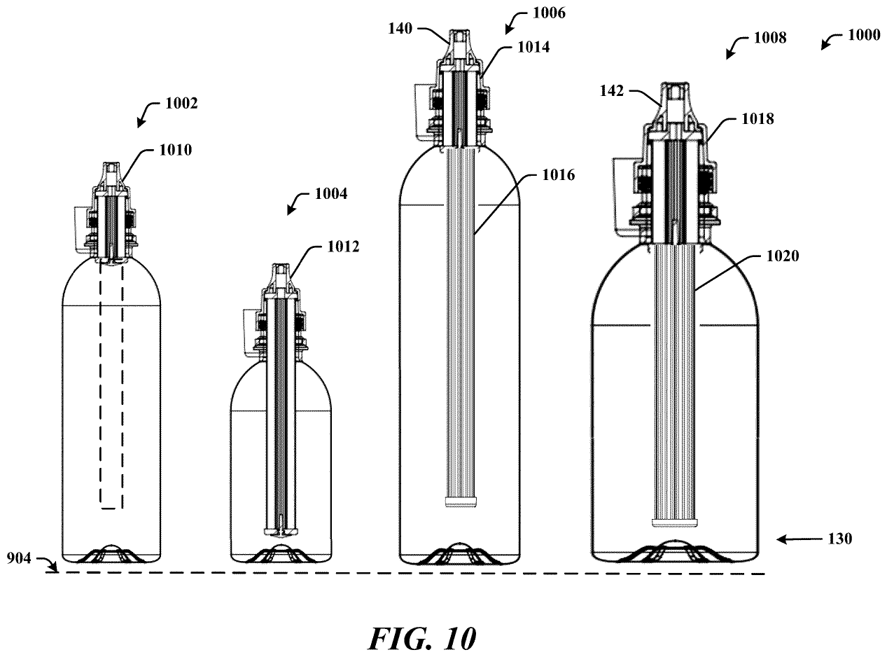

FIG. 10 illustrates a comparative view 1000 of various cap filter system orientations for various bottle formfactors of differing heights and volumes, in accordance with disclosed embodiments. A first bottle 1002 represents a standard sized plastic bottle (e.g., sixteen-ounce, twelve-ounce, etc.) employing a standard-sized cap filtering system 1010. A second bottle 1004 represents a shorter in height plastic bottle (e.g., six-ounce, eight-ounce, etc.) and another standard sized cap filtering system 1012 (similar to cap filtering system 1010).

A third bottle 1006 represents a taller bottle of greater volume (e.g., twenty-four ounce, eighteen-ounce, etc.), which then employs a standard cap system 1014 (similar to cap system 1010 and cap system 1012) with an extra-long filter cartridge 1016 which extends from a point proximate the base potion (or bottom) 130 to the draw-through object 140 of the cap system 1014.

A fourth bottle 1008 represents a shorter bottle than the third bottle 1006 and of a much greater volume (e.g., sixty-four ounces, five gallons, etc.), which then employs a larger cap system 1018 having overall size to accommodate the larger mouth of the bottle 1008. Additionally, given the larger bottle volume and bottle girth, a larger sized cylindrical cartridge 1020 (e.g., in length and diameter) can also be utilized which extends from a point proximate the base potion (or bottom) 130 to the draw-through object 142 of the cap system 1014.

It is to be appreciated that any bottle, container, etc., of any volume, height, radius, etc., can be outfitted with a suitably sized filtration system. For example, a variation of the disclosed micro-plastics filtration system can be implemented on multi-gallon (e.g., 5 gal., 6 gal, etc.) jugs used in gravity-feed water systems. More specifically, the inverted empty jug is replaced with a full jug by emplacement on top of the water system in an inverted orientation whereby the jug opening then drains water into the tank of the water system until a negative pressure is achieved in the jug, which equates to the external pressure of the jug. Thereafter, water is released only according to water amount drained from the spigot.

The inverted-jug implementation can place the filtration system at the spigot location, whereas the user draws water from the tank spigot, the micro-particulates will be filtered from the water drained into the user container the user employs to fill with water. Such filtration variation device can be provided with each jug purchased, or purchased separately for replacement on a regular basis. It can also be the case that the filtration device can be fitted over the opening of the jug before the jug is invertedly emplaced onto the water system. Thus, micro-plastics filtration can be achieved at the “jug-level” as the water drains from the mouth of the jug. A near equilibrium pressure can also be obtained as the mouth of the filtration system also is partially submerged under the water surface in the system tank. Accordingly, the filtration of the jug water takes place at the jug mouth.

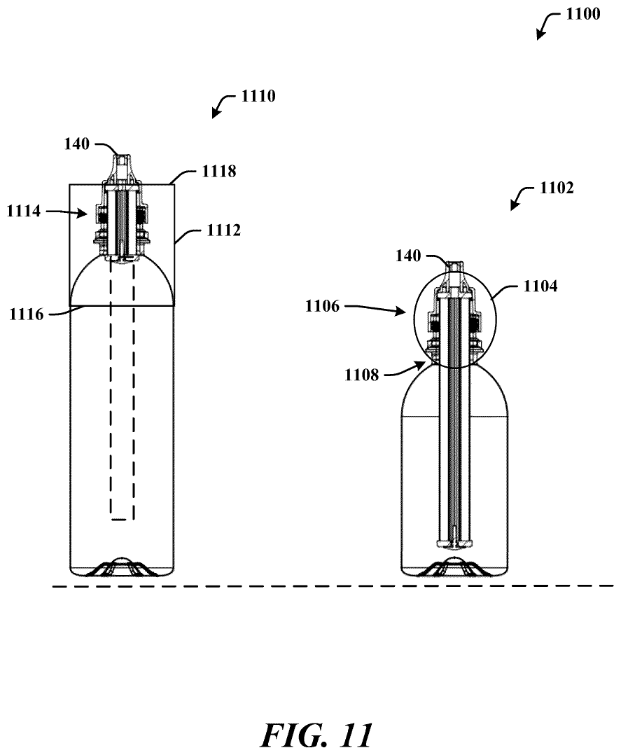

FIG. 11 illustrates alternative techniques 1100 for protecting the cap filter system of the disclosed architecture. Technique 1102 illustrates a spherical cover 1104 which can be applied to (e.g., slipped over) the cap filter system 1106 which extends above the base 1108 of the bottle neck. The cover 1104 is designed to still give the user access to the draw-through object 140 to enable consumption of the bottle liquid (e.g., water), if the user desires such access; otherwise, the cover 1104 can be used to slip completely over the draw-through object 140 while captured at the base 1108 of the bottle neck to encase the entire filtration assembly external to the bottle without providing user access.

Technique 1110 illustrates a cylindrical cover 1112 as a cover to protect the cap filter system 1114, and which can be applied to (e.g., slipped over) the cap filter system 1114 and down to the bottle shoulder 1116. As before, the cover 1112 can be designed to still give the user access through the top surface 1118 of the cover 1112 and while exposing the draw-through object 140 (and the mouth-piece end 142 in which is installed a check valve). However, this is not a requirement. The cover 1112 can be designed to capture/compress onto the bottle at the bottle shoulder area 1116 to keep the cover 1112 on the bottle and/or to slip past the bottle shoulder 1116area in a compression mode to grip the external of the bottle wall for a more secure retention of the cover 1112.

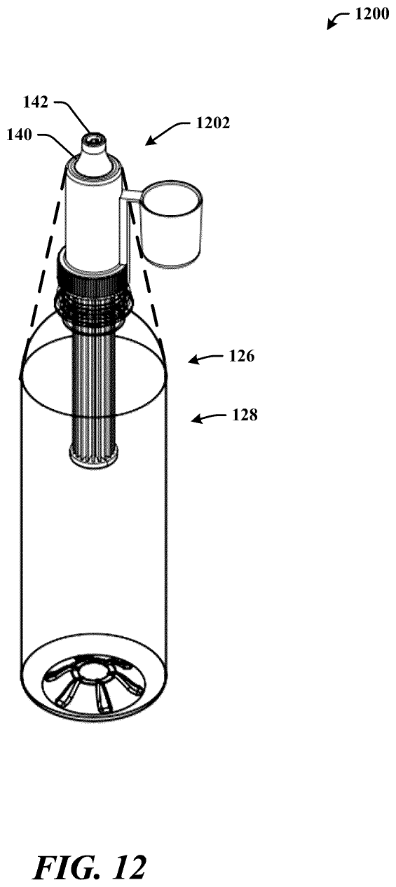

FIG. 12 illustrates a conical shaped cover 1202 as an alternative cover design to protect a cap filter system 1204. As before, the cover 1202 can be designed to still give the user direct access to the draw-through object 140 and the mouth-piece end 142 through the top surface 1204 of the cover 1202. The cover 1202 can be designed to grip bottle features such as the shoulder 126, for example, and/or to slip past the bottle shoulder 126 to the main body 128 for a more secure retention of the cover 1202.

FIG. 13 illustrates an expanded view of an alternative case/filter assembly 1300 where the disclosed filtration system can reside for shipping, storage, installation, use (potentially reuse or discard), for example. The case/filter assembly 1300 (shown in assembled form) comprises an assembly 1302 of six parts (in an expanded view): a top cover (or lid) 1304, a secondary cover 1306 (for user oral engagement to obtain bottle liquid therethrough), a cartridge system 1308 (for filtering the bottle fluid passed to the bottle opening), a threaded tightening body (or cover) 1310 (for receiving the bottom portion (which a comprises a bottom endcap)) of the filter cartridge and securing the parts (1304, 1306, 1308, and an optional gasket 1312) on to the threads of a compatible plastic bottle, and a bottom cover 1314; all concentrically aligned. The core element of the case assembly 1302 is the filter cartridge 1308, the top of which couples (e.g., in abutment) to the inside of secondary cover 1306.

The top cover 1304 couples onto the underlying upper portion of the secondary cover 1306. This coupling can be by threaded engagement or by snap-on engagement over threads and/or other types of surface protrusions (e.g., surface contours, etc.) which, for example, enable secure and stable capture of the secondary cover 1306 to the top portion of the cartridge 1308. All other couplings between adjacent parts (e.g., 1304, 1306, 1308, 1310, and 1314) can be designed for threaded engagement or by snap-on engagement over threads and/or other types of surface protrusions. The gasket 1312 slides over the threads/protrusions of the bottom cover 1314 and rests on a lip of the cover 1314.

Underlying the cartridge 1308, is the threaded tightening body (also tightening cover) 1310, which receives and concentrically aligns and abuts to the top end of the cartridge 1308 with the secondary cover 1306 and the top cover 1304.

The “coupling” mechanism between the top cover 1304 and the secondary cover 1306 can be by threaded engagement, between the secondary cover 1306 and the cartridge 1308 can be by threaded engagement, and, between the tightening body 1310 and the bottom cover 1314 by threaded engagement.

The assembled alternative case assembly 1300 of FIG. 13 also depicts a cross-sectional view 1316 of the assembly 1302 where threaded (and/or snap-on protrusions) are shown to enable secure concentric engagement of all parts (1304, 1306, 1308, 1310, 1312, and 1314), for storage, carrying, etc. In operation, the bottom cover 1314 can be removed, and the remaining parts can be captured to the compatible plastic bottle (or container) mouth (port via which liquid is inserted and removed) by threaded engagement (tightening down and backing off via the threads).

Thus, once the bottom cover 1314 is removed, the remaining assembly (parts 1304, 1306, 1308, 1310, and optionally, gasket part 1312) can be directly threaded down (via the interior threads of tightening cover 1310 onto a bottle having a compatible opening to begin filtering of the undesirable particulates in the contained liquid during consumption. The gasket part 1312 seals the interface between the upper lip 1313 of the bottom cover 1314 and the bottom inside surface 1322 of the tightening cover 1310 which seats against the upper lip 1313, when the bottom cover 1314 and tightening cover 1310 are threaded together.

It can also be the case in this embodiment that the bottom cover 1314, rather than removed, can be designed as an elongated small-volume liquid container in which a small volume of liquid is preserved and stored until the user removes the top cover and consumes the volume of liquid in a filtered way through the secondary cover 1306. Thus, the bottom cover 1314 can be an elongated container of various volumes sized for 2, 4, 6, 8, etc., ounces (e.g., a “pocket-sized” system) for quick use as intended.

Additionally, or alternatively, the bottom cover 1314 can be removed and the remaining assembly (after removal of top cover 1304) used to draw liquid from natural streams, puddles, ponds, snow-melt areas, lakes, wells, etc., up through the filtering capability such that the user receives for consumption clean water. The cross-sectional view 1316 more clearly shows the threaded portions (and/or snap-on protrusions) 1318 at various couplings of the assembly 1302. For example, threaded portions and/or snap-on protrusions 1318A enable coupling of the bottom cover 1314 to the tightening cover 1310, threaded portions and/or snap-on protrusions 1318B enable coupling of the tightening cover 1310 to the secondary cover 1306, and, threaded portions and/or snap-on protrusions 1318C enable coupling of the secondary cover 1306 to the top cover 1304. The view 1316 also shows a gasket 1320 (e.g., rubber O-ring) inserted and captured in a compatible groove 1309 around the outside of the top endcap of the cartridge 1308.

Parts 1304, 1306, and 1310 (and other parts, as well) can be designed to include a grip feature 1305 (e.g., enables holding, tightening, handling, and releasing, etc.) on the outer circumference to facilitate gripping the associated component (or part) for tightening (or coupling) and untightening (or decoupling/separation).

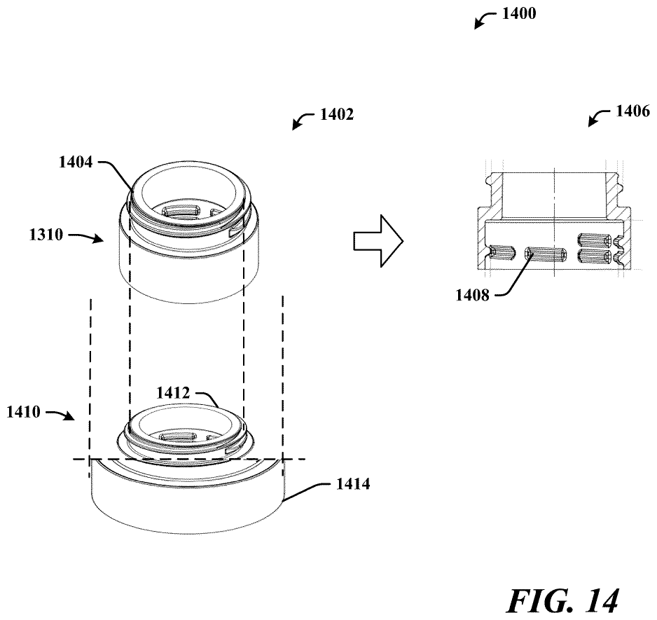

FIG. 14 illustrates a view 1400 of aspects of the tightening cover 1310 of FIG. 13, and design of an adapter cover 1410. As shown in oblique view 1402, the top portion 1404 of the cover 1310 includes a threaded part which enables coupling of the tightening cover 1310 to the internal threads 1318B of the internal underside of the above secondary cover 1306 (shown in FIG. 1300). A cross-sectional view 1406 of the cover 1310 shows threading and/or snap-on protrusions 1408 for coupling and/or capture of the threads of the bottom cover 1314. It can be a design where the protrusions enable a dual function of engaging the threaded portion for thread tightening and loosening capabilities, as well as alternatively enabling vertical pressure capture of the cover 1310 onto the underlying protrusions 1408 of the bottom cover 1314. Removal is the reverse process of pulling the cover 1310 over and away from the protrusions 1408 to separate the covers 1310 and 1314.

It is also within contemplation of the disclosed architecture that the cover 1310 can be designed as an adapter tightening cover 1410, where the top portion 1412 of cover 1410 remains the same dimensions and design as shown as the top portion 1404, but then is further designed where the lower (threaded tightening) portion 1414 can be larger in dimensions to accommodate containers with larger compatible (threaded or snap-on) mouths/openings, or be smaller in dimension to accommodate containers with a smaller mouth or outflow opening. Accordingly, the user can then choose to obtain different adapter covers 1410 for various liquid filtration container needs.

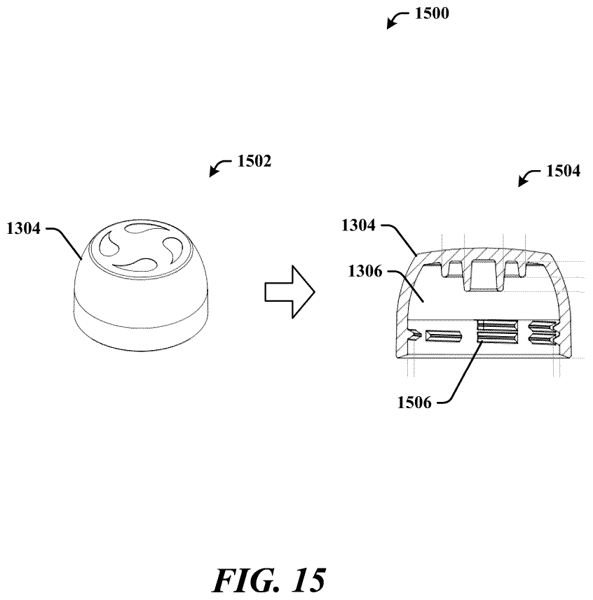

FIG. 15 illustrates views 1500 of aspects of the top cover 1304 of FIG. 13, in one embodiment. As shown in oblique view 1502 and referring additionally to FIG. 13, the top cover 1304 includes a lower inside (and out-of-view) threaded (or protrusion) part 1318C (of FIG. 13), which enables coupling of the top cover 1304 to the external threads (or protrusions) 1318C of the secondary cover 1306 (shown in FIG. 1300). A cross-sectional view 1504 of the parts 1304 and 1306 shows threading and/or snap-on protrusions 1506 (similar to threading and/or snap-on protrusions 1408) for coupling and decoupling of the threads/protrusions of the tightening cover 1310.

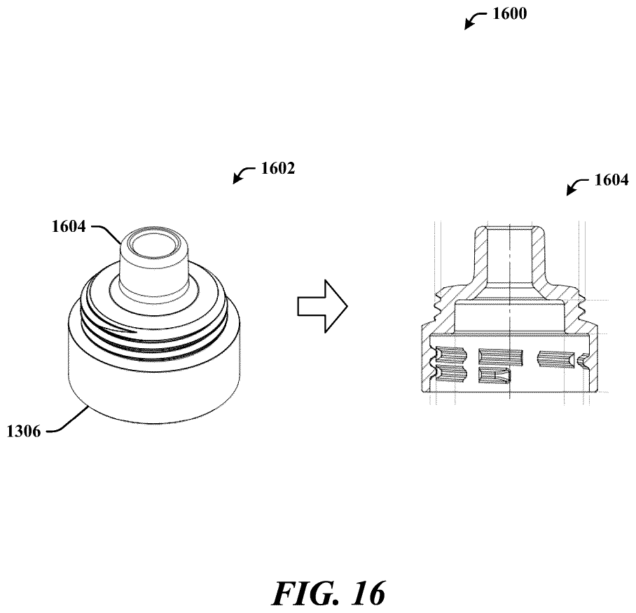

FIG. 16 illustrates views 1600 of aspects of the secondary cover 1306 of FIG. 13, in one embodiment. In an oblique view 1602 and referring additionally to FIG. 13, the cover 1306 includes a threaded portion (similar to the threaded (or protrusion) part 1318C of FIG. 13). The cover 1306 includes the access port 1604, which functions similar to the mouth piece or nipple 142 of FIG. 1, to enable the user draw liquid from the associated bottle or container. In a cross-sectional view 1604, the cover 1306 includes lower-inside threads (or protrusions) for securely coupling and decoupling the cover 1306 from the tightening body 1310.

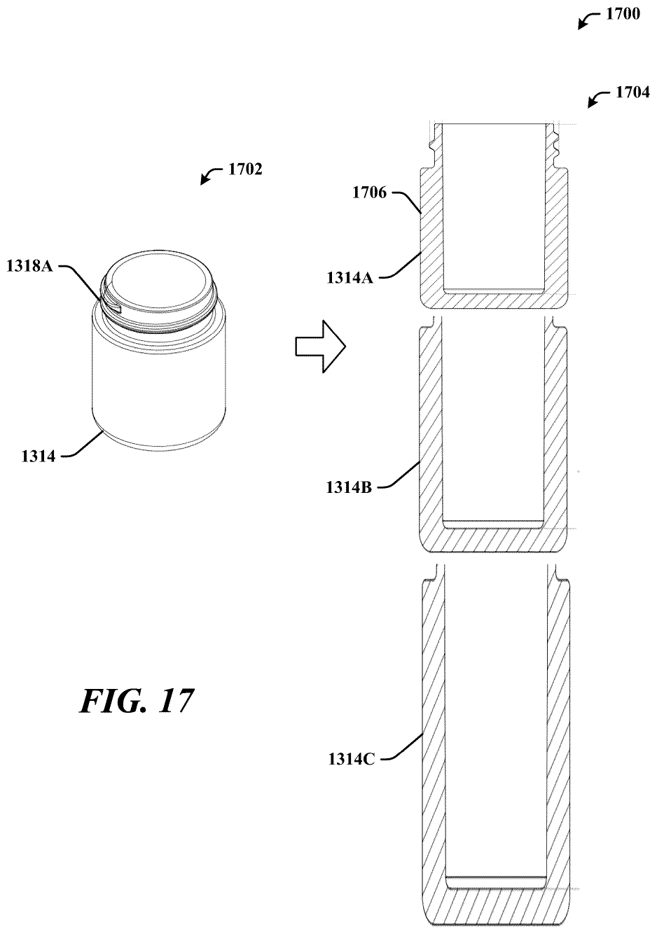

FIG. 17 illustrates different views 1700 of the bottom cover 1314 of FIG. 13, in one embodiment. In an oblique view 1702 and referring additionally to FIG. 13, the bottom cover 1314 includes a threaded portion (similar to the threaded (or protrusions) part 1318A of FIG. 13). In a cross-sectional view 1704, the wall 1706 of the cover 1314 is sufficiently thick and rugged to survive dropping events, puncture events, compression events, etc. (e.g., sitting on, stepping on, etc.) to ensure the interior is clean, structurally sound, and remains free of any possible debris prior to use with a liquid. Although, it is understood that in use, any particulates which happen to be in the bottom cover 1314, will be filtered through the normal liquid filtering process.

The view 1704 also indicates that the bottom cover 1314 can be elongated for the same or different purposes. Accordingly, where cover 1314A can be considered the standard cover dimensions, an elongated cover 1314B can be longer than the standard cover 1314A (e.g., by increments of inches, half-inches, etc.). A further elongated cover 1314C can be longer than both of the covers 1314A and 1314B. For example, cover 1314C can be increments of inches, half-inches, etc., longer than elongated cover 1314B. Thus, the various lengths of the bottom covers (1314A, 1314B, and 1314C) can also retain the threading compatible with the other assembly parts of the case assembly 1300.

In cooperation with changes in the adapter tightening cover 1410 (of FIG. 14), any one or more of the covers 1314A, 1314B, and/or 1314C, standard sized 1314A or elongated (1314B, 1314C), can alternatively include an increased diameter to accommodate larger-mouthed containers or a reduced diameter to accommodate smaller-mouthed containers. Accordingly, the cap filtration system finds applicability to a wide variety of different-dimensioned and disposable flexible walled bottles, as well as/disposable/non-disposable hard walled bottles/containers capable of utilization with the disclosed filtration system for at least micro-particulate filtering.

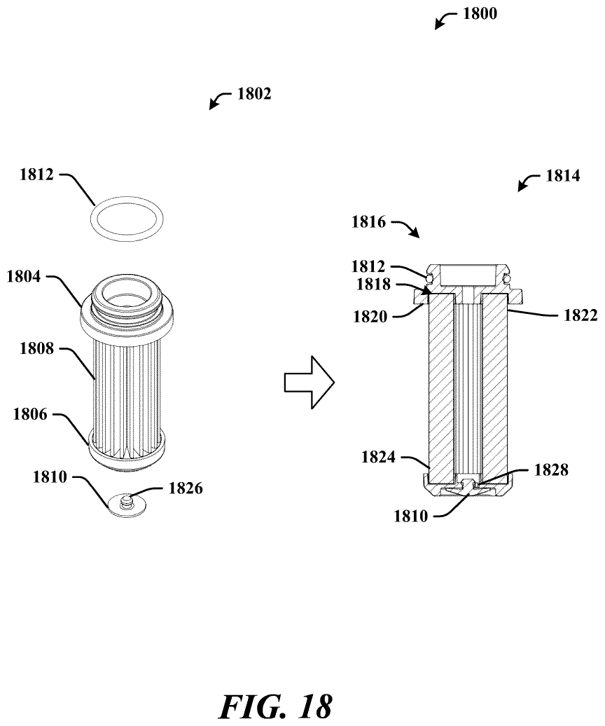

FIG. 18 illustrates different filter cartridge views 1800 in accordance with an alternative filter cartridge embodiment. An expanded oblique view of a filter cartridge assembly 1802 is shown. The assembly 1802 includes a top endcap 1804, a bottom endcap 1806, and the filter element 1808, captured and secured between the endcaps (1804 and 1806). The assembly 1802 includes a gasket 1812, which can be a flexible toroidal-shaped gasket (e.g., an O-ring) made of a liquid repellant material such as rubber (or nylon, etc.). The gasket 1812 can be made to flex over and into a groove in the top endcap 1804. The bottom endcap 1806 is designed to receive an (umbrella or “check”) valve 1810, which impacts fluid flow into the assembly cartridge 1808. A cross-sectional and collapsed view 1814 of the assembled cartridge system 1816 shows the in-situ relationships of the parts.

The cross-sectional view 1814 of the top endcap 1804 depicts an alignment groove 1818 in the underside surface 1820 and into which a top end 1822 of the filter element 1808 is received in a sealable alignment to prevent leakage of particulates into the center (or core) conduit of the element 1808, and what could ultimately be consumed by the user. The bottom endcap 1806 is sealably fixed to the bottom end 1824 of the element 1808 to prevent leakage of particulates into the center (or core) conduit of the cartridge 1808. The flexible disc on the check valve 1810 comprises a capture nub 1826 which is captured into a concentrically aligned port 1828 in the bottom endcap 1806. In operation, the capture nub 1826 retains the valve nub 1826 in the captured state, yet the function of the flexible surface of the butterfly valve 1810 blocks liquid from entering the center conduit of the cartridge 1808.

It may be the case where “blow-back” occurs by the user exhaling back into the cap filtration system. Although there is the top check valve 144 (see FIG. 1), the presence of the bottom check valve 1810 ensures that water in the cartridge at that time, either remains in the cartridge conduit or is expelled back into the container volume to be filtered again, in the least.

In one embodiment, referring again to FIG. 13, the entire assembly from the cover 1304 down to the bottom cover 1314 can be provided as single unit for sale and/or purchase. In an alternative process, the cartridge 1308 can be purchased separately. Referring again to FIG. 18, in still another process, the assembly 1802 can be packaged as a single unit for purchase, and/or as in collapsed view 1814, packaged as a single unit with the gasket 1812 installed.

The check valve 1810 operates, in a “relaxed” mode (relaxed in the sense that there is no pressure (a “neutral” pressure which is neither positive nor negative)). In an active mode, positive and/or negative pressure can be applied to obtained filtered liquid at the container mouth. A positive pressure can occur when the bottle wall is squeezed to force container liquid through the external walls of the cartridge medium and up to the mouth. A negative pressure can occur by the user imposing a partial vacuum at the bottle mouth to receive the container liquid forced up and through the cartridge walls to the container mouth.

In either case, there may be residual already-filtered liquid that remains trapped in the filter assembly system until the next non-neutral pressure action. The check valve 1810 can be designed to allow trapped filtered liquid to drain back into the bottle liquid via the check valve 1810 and undergo the filtering process again in the next process when the liquid is brought to the bottle mouth. In another implementation, the valve 1810 can be designed to prevent any already-filtered water remaining in or above the filter system, to drain back into the bottle water.

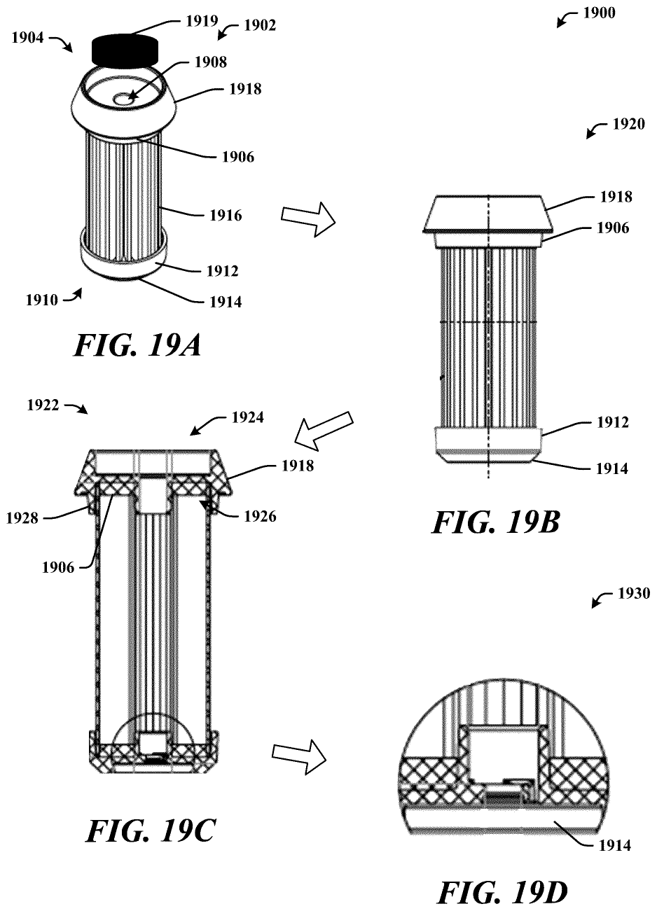

FIGS. 19A-19D illustrate various views of an alternative filter cartridge assembly 1900 which can be employed for filtering particulates from water of disposable handheld liquid bottles (also as container(s)), in accordance with a disclosed embodiment. In an oblique view of a filter cartridge module 1902 (in FIG. 19A), the cartridge module 1902 comprises a top end 1904 (closer to the bottle/container mouth) and a top endcap 1906 via which filtered water exits though a top endcap orifice 1908 (similar to, for example, orifice 338 of FIG. 3 and (pathway) orifice 216 of FIG. 2) and from the disposable bottle/container. The filter cartridge module 1902 further comprises a bottom end 1910 (farther from the bottle mouth), which includes a bottom endcap 1912 (in which a check valve 1914 is installed).

A filter media 1916 (similar in media composition and variable length construction at least to the following cartridges/media: media 124, cartridge 301, cartridge 404, cartridge 510, cartridge 706, cartridge 806, cartridge 1016, cartridge 1020, to name only a few of the disclosed cartridges and media) is installed as interstitial to the top end 1904 and the bottom end 1912, where the top endcap 1906 is affixed to the top end of the filter media 1916, and the bottom endcap 1912 is affixed to the bottom end 1910 of the filter media 1916.

The mechanism(s) of endcap attachment to the filter media ends (top end 1904 and bottom end 1910) and the respective endcaps (top 1906 and bottom 1912) can be via a food grade glue such as HM302 hot melt adhesive. Accordingly, any unlikely food grade adhesive particulates (e.g., nano-particles) and/or a partial in-solution food grade adhesive can be filtered from the water and will not negatively affect the consumer.

The cartridge module 1902 also comprises a cylindrical and angled (e.g., beveled) interface piece 1918, which is aligned concentrically with the endcap 1906 and attached to the top endcap 1906. The attachment technique can be a food grade glue such as HM302 hot melt adhesive. The top opening (closer to the bottle mouth) of the interface piece 1918 can be smaller in diameter than the bottom opening (farther from the bottle mouth) of the interface piece 1918. Thus, the bottom opening can receive and be affixed to the top endcap 1906 of the filter cartridge 1916.

The piece 1918 can be configured to receive one or more “puck” filter(s) 1919 for a combination of filtering purposes of particulates such as biological germs, or simply non-biological particulates when employing filter dimensions suitable for insertion into the inner volume of the piece 1918, and over the top endcap orifice 1908. In this implementation, the container liquid is passed through multiple filtrations: via the cartridge media, and then via the puck filter media.

In one implementation, the interface piece 1918 can operate where a downward pressure on the top opening functions to form a compression seal such that no liquid leaks by the seal. Alternatively, the interface piece 1918 can be configured such that the associated top opening receives a portion of an overlying piece (not shown) into the top opening. The portion of the overlying piece is then captured within the top opening. This is shown in FIG. 19B.

FIG. 19B shows a sideview 1920 of the filter cartridge module 1902, which comprises the interface piece 1918 affixed to the top endcap 1906, and which now more clearly shows as comprising the beveled (angle-cut) piece form affixed to an underlying circular endcap 1906. The beveled interface piece 1918 enables a secure leak-free contact interface to an overlying cap top structure (shown in FIG. 20) when installed to the mouth of the disposable bottle. The angle-cut interface piece 1918 can be securely attached to the underlying endcap piece by any different techniques. As previously indicated, the interface piece 1918 also includes the top opening which exposes the filter cartridge orifice 1908 via which the filtered water is routed from the disposable plastic bottle through the filter cartridge assembly 1900 to the consumer. In the sideview 1920, the bottom endcap 1912 and the check valve 1914 are shown.

FIG. 19C shows a cross-sectional view 1922 of the filter cartridge module 1902 of FIG. 19A. The view 1922 of the interface piece 1918 depicts a top opening 1924 and a bottom opening 1926. In this configuration, the top opening 1924 and the bottom opening 1928 are the same diameter. The bottom opening 1928 fits over the top endcap 1906 of the filter cartridge (media) 1916. The bottom opening 1926 can form a compression fitting over the top endcap 1906 sufficient to seal the bottom opening 1926 to the top endcap 1906, and sufficient to prevent any leak of liquid or particulates. Alternatively, the food grade glue can be employed to provide a seal at that interface. In an alternative implementation, the piece 1918 and top endcap 1906 can be fabricated as a single unit.

As also depicted, the bottom opening 1926 of the interface piece 1918 also includes a lower rim portion 1928 which extends below and underneath the angular portion 1918 and the top endcap 1906. The lower rim portion 1928 extends the entire circumference of the cartridge, just below (or proximate) the lower side (or surface) of the top endcap 1906.

FIG. 19D shows an expanded view 1930 of the bottom endcap 1912 and check valve 1914. As shown in this embodiment, the bottom endcap 1912 securely captures the check valve 1914 and receives the bottom end 1910 of the filter cartridge 1916.

FIG. 20 illustrates an implementation of an alternative case/filter assembly 2000 where the disclosed filtration system can reside for shipping, storage, installation, use (and potentially reuse and/or discard). The case/filter assembly 2000 is depicted in an expanded format 2002, assembled format 2004, and cross-sectional format 2006. Similar in some ways to the assembly of FIG. 13, the expanded view 2002 comprises five parts: a top cover (or lid) 2008, a secondary cover 2010, a cartridge filtration system 2012, a thread tightening body 2014, and the bottom cover 2016.

The secondary cover 2010 enables (configured to) user oral engagement of the underlying filtration system to obtain bottle liquid therethrough, a cartridge (filter) system 2012 enables filtering the bottle fluid passed to the bottle opening or mouth), the threaded tightening body (or cover) 2014 enables receiving the bottom portion (which a comprises a bottom endcap)) of the filter cartridge 1916 and securing the parts (top cover 2008, secondary cover 2010, cartridge system 2012) onto the threads of a compatible plastic bottle; the bottom cover 2016 enables protective function when not installed. The bottom cover 2016 can also include venting slots 2028 on its bottom face to allow the filter to remain dry until such time as the associated filter cartridge is placed into use. All of these parts are concentrically aligned along the vertical axis 2030 with each other and with the bottle mouth.

The top cover 2008 couples onto the underlying upper portion of the secondary cover 2010. This coupling can be made by any one or more of at least the following techniques: by threaded engagement between the top cover 2008 the compatible threads of the secondary cover 2010, by snap-on engagement of the top cover 2008 over the threads of the secondary cover 2010, compression capture by the top cover 2008 over and to the threads of the secondary cover 2010, and/or other types of surface protrusions (e.g., surface contours, etc.) which, for example, enable secure and stable capture of the secondary cover 2010 to the top portion of the cartridge system 2012.

All other couplings between adjacent parts (e.g., top cover 2008, secondary cover 2010, cartridge system 2012 (which can comprise the filter cartridge 1916 (similar to cartridge 404 of various lengths), tightening body 1310 or 2014, and bottom cover 2016) can be designed for any one or more of threaded engagement, snap-on engagement over threads or other types of surface protrusions, compression capture, and so on. The cartridge system 2012 is depicted with the angular interface piece 1918 affixed to the top end of the filter cartridge 1916, and showing the filtered-water orifice 1908 via which filtered water is drawn from the disposable bottle or container.

Underlying the bottom end of the cartridge 1916 in this expanded view 2002, is the threaded tightening body (also tightening cover) 2014, which receives and concentrically aligns the bottom end 1910 of the cartridge 1916 with the bottom cover 2016. In this embodiment, the cartridge 1916 and components of the cartridge system 2012 (e.g., bottom endcap 1912 and check valve 1914) slide through the central opening of the tightening cover 2014 until a lower surface portion of the underside of the top endcap 1906 rests onto the top rim 2020 of a threaded portion 2022 of the tightening cover 2014.

When all parts are coupled together, the secondary cover 2010 threadedly tightens to the top threaded portion 2022 of the underlying tightening cover 2014 thereby securing the cartridge system 2012 firmly in place within the case/filter assembly 2000. The bottom cover 2016 tightens into the inside threads of the tightening cover 2014. When to be used, the bottom cover 2016 is removed and the remaining assembly is threaded down onto the bottle mouth threads. Note, that in this embodiment, the bottom cover 2016 can be smaller in diameter than the bottom cover 1314 of FIG. 13. Accordingly, as described in, the disclosed filter assemblies can be designed for use in disposable/non-disposable containers of different mouth dimensions.

The secondary cover 2010 in this embodiment comprises a longer mouth piece 2024 than depicted in FIG. 13, for example. This increased length of mouth piece 2024 facilitates easier and more comfortable usage of the filter assembly capabilities by the user, as described herein. The cover 2008 is then sized accordingly to provide a tight seal on the secondary cover 2010 thereby encasing and protecting the mouthpiece 2024 from unwanted external particulates and environmental conditions (e.g., humidity, dust, gases, etc.).

The assembled format 2004 in a compacted view provides a clear delineation of the parts when assembled, where the bottom cover 2016 includes a diameter smaller than the diameter of the bottom cover 1314 of FIG. 13. As with the top cover 1304 of FIG. 13, the top cover 2008 also comprises an ornamental top showing curved drops which match the curvature of the cover 2008. The cross-sectional format 2006 illustrates the relationships of the pieces and piece features when in the completed-assembly format 2004.

In comparison of the assembly in format 2006 with the assembly view 1316 in FIG. 13, the top cover 1304 is shorter in height than the top cover 2008. Accordingly, the taller mouth piece 2024 can be employed rather than the shorter mouth-piece 1307 in FIG. 13. The mouth piece 2024 is generally similar in design but still alternative to the mouth piece end (or “nipple”) having the check valve 144, in FIG. 1.

Thusly, when the user removes the top cover 2008, the user is presented with the taller mouth-piece 2024 which is easier to engage and to use. As shown, the interior design of the top cover 2008 and the top cover 1304 of associated assemblies provide suitable support for protecting the underlying (interior) mouth pieces (2024 and 1307) when the bottle is in frequent use and undergoes impacts (e.g., being dropped, tossed, carried, etc.) during use.

The cross-section of the top and longer cover 2008 comprises the interior support structure 2026 which encloses the associated longer mouth-piece 2024. Likewise, the shorter cover 1304 also comprises the shorter interior support structure 1330 which encloses the shorter mouth-piece 1307. In other words, in both designs, the cover interiors are configured to enclose (surround) the respective mouth-pieces to prevent damages to the mouth-pieces under all use conditions. Additionally, in both cases, the internal support structures 1330 and 2026 are of sufficient height (even with the height of the exposed mouth-piece end) to protect the exposed tip of the respective mouth-piece (1307 and 2024).

Similarly, in both designs, the interior support structures (1330 and 2026) are pressed downward on the top end of the cartridge assembly when the associated cover (1304 and 2008) are tightened onto the threads of the associated tightening covers (1310 and 2014).

The cross-section view 2006 shows the thread-pairs where the threads of the above cover interact with the underlying piece threads, for example. Accordingly, thread pair 2023 represents the thread interactions for the internal threads of the cover 2008 engaging the outside threads of the secondary cover 2010. Thread pair 2025 represents the thread interactions for the internal threads of the secondary cover 2010 engaging the outside threads of the tightening body cover 2014.

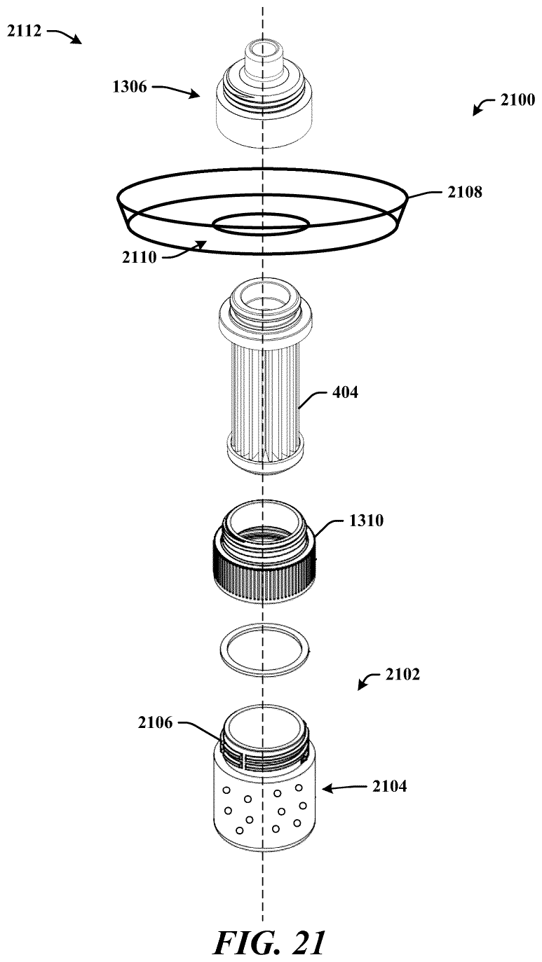

FIG. 21 illustrates an alternative filter embodiment 2100 which includes a flavor module (also, referred to as a flavor attachment) 2102, for implementation with a larger cover container 2112, in accordance with an alternative embodiment. The module 2102 includes a perforated housing 2104 in a cylindrical shape, with one open end (referred to as the top end, which is closest to the threads and filter cartridge) of the cylinder shape having a threaded feature 2106 for tightening (securing) the flavor module 2102 onto the compatible threads of the threaded tightening cover 1310 (of FIG. 13) or tightening cover 2014 (of FIG. 20).

Similarly, the flavor module 2102 can be designed to be positioned into the smaller diameter bottom cover 2016 (of FIG. 20) with the cover 2016 perforated to release flavoring into the liquid of the bottle/container and/or flavor the liquid as the liquid is drawn through the perforations 2104 and upward into the filter cartridge system 2012 and cartridge 1916. The opposite end (also referred to as the (distal) bottom end; farthest from the filter cartridge) of the cylindrical shape is closed so that there is only a single opening (threaded feature attachment) to the flavor module 2102.

Although depicted with perforations on the sides of the flavor module 2102, such perforations can also be placed into the bottom end (not viewable) of the flavor module 2102. Additionally, the flavor module 2102 can be manufactured in differing sizes (e.g., volumes, lengths) (modules such as 1314A, 1314B, 1314C, etc., of differing dimensions such as lengths, diameters, and volumes, etc.) such as depicted in FIG. 17, where each differing length module can also employ perforations for the release of the flavor constituent (e.g., powder, liquid pod, dissolvable (slow-release) hard pill, etc.) into the liquid of the container.

In operation, one or more flavor carrier(s) such as a compressed (or hard) pill of a single or multiple flavors, can be inserted into the perforated module 2102, and captured there by retightening the module 2102 to the tightening cover 1310 (or e.g., cover 2014). The flavor carrier(s) dissolves the flavor(s) into the container solution as the container is jostled intentionally or unintentionally (e.g., during use, carrying, etc.). The flavor(s) dissolve into solution of the contained liquid, and are drawn through the filter cartridge 404 and from the container in the container liquid. The filter cartridge 404 (or cartridge 1916 or cartridge module 1902) continues to filter microplastics and other unwanted particulates while passing the flavor(s) through in the liquid being consumed.

While the filter cartridge 404 (or cartridge 1916 or cartridge module 1902) will remove at least micro-particulates such as plastic (for the container, or other sources), once entirely dissolved, the flavored liquid reaches the consumer without the flavor being filtered. The user can be instructed to shake the container of liquid to initiate quicker dissolving of the flavor constituent into the liquid, although this is not a requirement.

The filter cartridge (e.g., cartridge 404 of FIG. 4) can be sized for the length of the given module 2102. As indicated herein, the filter cartridge 404 (and other suitable cartridges disclosed herein) can be designed for different lengths (e.g., cartridge 706 of FIG. 7, cartridge 806 of FIG. 8, etc.) to accommodate liquid filtering of containers of differing sizes (e.g., lengths, volumes, etc.).

The filter embodiment 2100 can also comprise a container cover 2108, which can be designed to fit portable handheld hard-walled drink containers with pop-off covers, carafes, pitchers with a flip-open lid, tumblers, etc. Accordingly, the cover(s) 2108 which can be designed to fit many different container dimensions and designs can now be made available as generally illustrated as the cover 2108. The cover 2108 comprises a capped central opening 2110 to accommodate the disclosed filter assembly system 2112. The cap can be removed from opening 2010 and the cover 2108 configured with the filter cartridge assembly. The cartridge assembly (parts 1306, 404, 1310, and 2102) can be configured for water filtering only, or as flavor introduction assembly (with perforated flavor insert).

The assembly is assembled to capture (tighten down to) the larger container cover 2108 at the opening 2110, with the secondary cover 1306 (for oral engagement) and threaded tightening cover 1310. The entire cover assembly 2112 then fits snuggly into the top opening 2110 of the associated container (not shown), as do most all similar types of containers and container covers. As before, the user can choose to forgo the flavor implementation via module 2102, for water micro-particulate filtering. Alternatively, as indicated herein, the flavor module 2102 can be used to provide flavoring while also filtering for micro-plastics.

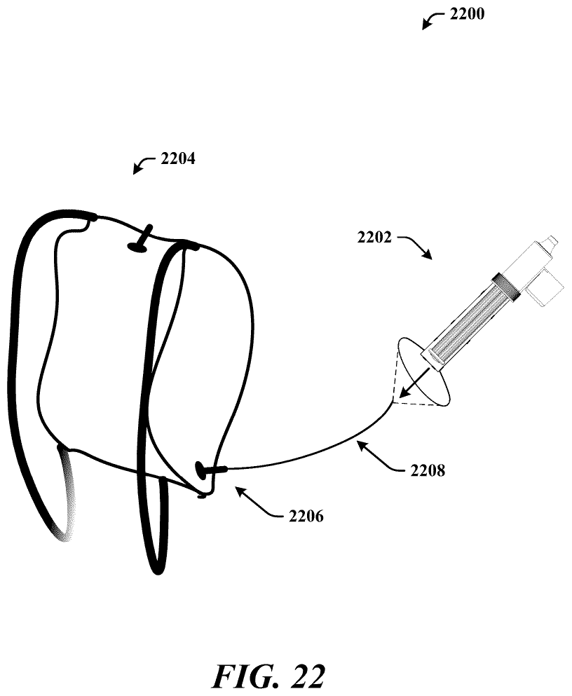

FIG. 22 illustrates yet another alternative implementation 2200 where the disclosed filtration system 2202 can be employed. Here, a backpack bladder 2204 commonly used by a person to carry water for extended periods of time (e.g., hiking, firefighting, etc.), may be constructed of materials (e.g., plastics) that sluff off micro-particulates into the water to be consumed. The disclosed filtration system 2202 can be designed for insertion into and capturing by (temporarily or permanently) a backpack port 2206 directly or via an extension tube 2208 via which the water can be drawn for consumption.

In an alternative application, it is within contemplation that the general implementation of the disclosed architecture for filtering micro-particulates from a liquid, such as water, can be applied as well to pressurized canisters (e.g., plastic, composites using plastic, etc.) which enable the use of a gas (e.g., air, purified oxygen, etc.) can be filtered to remove at least micro-particulates such as micro-plastics, which may be introduced or reside in the container from the manufacturing process or pressurization process, when operating the pressure container to release a gas for inhalation into the lungs.

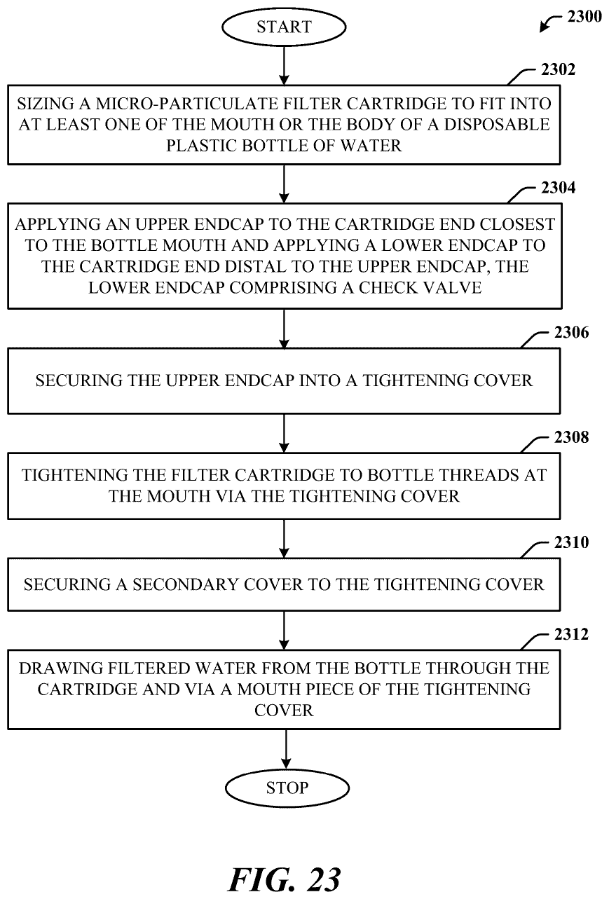

FIG. 23 illustrates a method 2300 of filtering microplastics from a handheld plastic disposable bottle in accordance with a disclosed embodiment. At 2302, a micro-particulate filter cartridge is received and sized to fit into at least one of the mouth or the body of the disposable plastic bottle of water. At 2304, an upper endcap is applied to the cartridge through which filtered water passes, and a lower endcap is applied to the cartridge end distal to the upper endcap, the lower endcap houses a check valve. At 2306, the upper endcap is secured into a tightening cover. At 2308, the filter cartridge is tightened to the bottle threads at the mouth via the tightening cover. At 2310, a secondary cover is secured to the tightening cover. At 2312, water is drawn from the bottle via a mouth piece of the tightening cover.

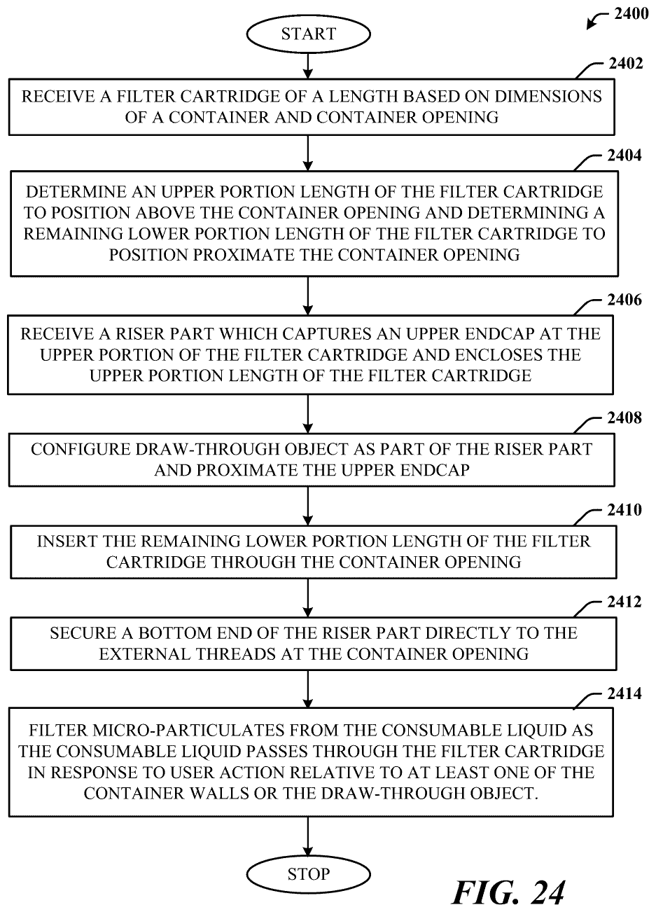

FIG. 24 illustrates an alternative method 2400 of filtering microplastics from a handheld plastic disposable bottle in accordance with a disclosed embodiment. At 2402, a filter cartridge of a length based on dimensions of a container and container opening, is received. At 2404, an upper portion length of the filter cartridge to position above the container opening and determining a remaining lower portion length of the filter cartridge to position proximate the container opening, is determined. At 2406, a riser part is received which captures an upper endcap at the upper portion of the filter cartridge and encloses the upper portion length of the filter cartridge. At 2408, a draw-through object is configured as part of the riser part and proximate the upper endcap.

At 2410, the remaining lower portion length of the filter cartridge is inserted through the container opening. At 2412, a bottom end of the riser part is secured directly to the external threads at the container opening. At 2414, micro-particulates are filtered from the consumable liquid as the consumable liquid passes through the filter cartridge in response to user action relative to at least one of the container walls or the draw-through object. The method can further comprise extending a lower endcap of the remaining lower portion length of the filter cartridge through the container opening and further into a main body portion of the container.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A liquid filtration system, comprising:
a filter subsystem configured to attach to external threads of a container opening of a container holding a consumable liquid, and to pass the liquid therethrough, the filter subsystem comprising:
a filter cartridge configured to pass the consumable liquid therethrough, the filter cartridge comprising a top endcap, a bottom endcap, a filter media secured between the top endcap and the bottom endcap, and a central liquid pathway internal to the filter media and which extends between the top endcap and bottom endcap;
an attachment mechanism comprising a tightening body, the tightening body comprising an annular center with a top opening having external threads and a bottom opening having internal threads, the tightening body configured to receive the bottom endcap of the filter cartridge through the top opening, through the annular center, and through the container opening, and further configured to position the top endcap against the top opening of the annular center;
the attachment mechanism further comprises a secondary cover configured with internal threads and external threads distal to the internal threads, the internal threads of the secondary cover tighten onto the external threads at the top opening of the tightening body to secure the top endcap of the filter cartridge against the top opening of the tightening body; and
a draw-through object proximate the external threads of the secondary cover, the draw-through object configured to enable access to the consumable liquid from the filter cartridge.

2. The liquid filtration system of claim 1, wherein the internal threads of the tightening body are configured to tighten directly onto the external threads of the container opening, absent an interstitial connection between the internal threads of the tightening body and the external threads of the container opening.

3. The liquid filtration system of claim 1, wherein the filter media is configured as a non-electrically charged media.

4. The liquid filtration system of claim 1, wherein the filter media is a multilayered media configured to filter micro-particulates from the liquid.

5. The liquid filtration system of claim 1, wherein the draw-through object is fabricated as part of the secondary cover, the draw-through object fabricated proximate the external threads of the secondary cover.

6. The liquid filtration system of claim 1, further comprising at least one of a top protective cover or a bottom protective cover, the top protective cover configured to secure over a portion of the secondary cover to protect the liquid in the filter subsystem, and the bottom protective cover configured to thread onto the external threads of the tightening body cover to protect the filter cartridge from external particulates.

7. The liquid filtration system of claim 1, further comprising a riser part configured to receive one of multiple different filter cartridges of different lengths, the riser part and received filter cartridge further configured to install proximate the top of the tightening body and proximate the bottom of the secondary cover.

8. The liquid filtration system of claim 1, further comprising a riser part configured as part of the attachment mechanism, the riser part of a specified length and configured to accommodate a filter cartridge compatible with the specified length, the riser part further configured to capture the top endcap of the filter cartridge to form a captured filter cartridge, and when installed, the captured filter cartridge extends above the container opening and internally below the container opening.

9. The liquid filtration system of claim 8, wherein the specified length of a first filter cartridge ranges from about one inch to about three inches, the specified length of a second cartridge ranges from about three inches to about six inches, and the specified length of third cartridge ranges from about six inches to about nine inches.

10. The liquid filtration system of claim 1, wherein the top endcap of the filter cartridge fabricated as a top endcap gasket having a beveled opening, the beveled opening configured to compressively seal against an internal bottom part of the secondary cover, the internal bottom part located above the internal threads of the secondary cover.

11. The liquid filtration system of claim 1, further comprising a riser part configured to receive a filter cartridge having a bottom endcap, the bottom endcap installed to be positioned proximate a top of the container opening.

12. The liquid filtration system of claim 1, the bottom endcap further comprising a valve configured to enable pressure equalization between an internal atmosphere of the container and an external atmosphere of the container.

13. The liquid filtration system of claim 1, further comprising a disc filter configured to install between the top endcap and the bottom of the secondary cover to provide additional filtering of the container liquid.

14. The liquid filtration system of claim 1, wherein the filter subsystem is at least one of replaceable, disposable, or recyclable.

15. A liquid filtration system, comprising:
a filter subsystem configured to attach to external threads of a container opening of a container holding a consumable liquid, and to pass the liquid therethrough, the filter subsystem comprising:
a filter cartridge configured to pass the consumable liquid therethrough to filter micro-particulates therefrom, the filter cartridge comprising a top endcap, a bottom endcap, a filter media secured between the top endcap and the bottom endcap, and a central liquid pathway internal to the filter media and which extends between the top endcap and bottom endcap;
an attachment mechanism comprising a tightening body, the tightening body comprising an annular center with a top opening having external threads and a bottom opening having internal threads, the tightening body configured to receive the bottom endcap of the filter cartridge through the top opening, through the annular center, and through the container opening, and further configured to position the top endcap against the top opening of the annular center, the internal threads of the tightening body configured to tighten directly onto the external threads of the container opening and without any interstitial connection between the internal threads of the tightening body and the external threads of the container opening;
the attachment mechanism further comprises a secondary cover configured with internal threads and external threads distal to the internal threads, the internal threads of the secondary cover tighten onto the external threads at the top opening of the tightening body to secure the top endcap of the filter cartridge against the top opening of the tightening body; and
a draw-through object proximate the external threads of the secondary cover and configured to enable access to the consumable liquid from the filter cartridge, the draw-through object is fabricated as part of the secondary cover and fabricated proximate the external threads of the secondary cover.

16. The liquid filtration system of claim 15, further comprising a riser part configured to receive one of multiple different filter cartridges of different lengths, the riser part and received filter cartridge further configured to install proximate the top of the tightening body and proximate the bottom of the secondary cover.

17. The liquid filtration system of claim 15, further comprising a riser part configured as part of the attachment mechanism, the riser part of a specified length and configured to accommodate a filter cartridge compatible with the specified length, the riser part further configured to capture the top endcap of the filter cartridge to form a captured filter cartridge, when installed, the captured filter cartridge extends above the container opening and internally below the container opening.

18. The liquid filtration system of claim 17, wherein the specified length of a first filter cartridge ranges from about one inch to about three inches, the specified length of a second cartridge ranges from about three inches to about six inches, and the specified length of a third cartridge ranges from about six inches to about nine inches.

19. The liquid filtration system of claim 15, wherein the top endcap of the filter cartridge fabricated as a top endcap gasket having a beveled opening, the beveled opening configured to compressively seal against an internal bottom part of the secondary cover, the internal bottom part located above the internal threads of the secondary cover.

20. The liquid filtration system of claim 15, further comprising a riser part configured to receive a filter cartridge having a bottom endcap, the bottom endcap installed to be positioned proximate a top of the container opening.

21. The liquid filtration system of claim 15, the bottom endcap further comprising a valve configured to enable pressure equalization between the container and external environment.

22. The liquid filtration system of claim 15, further comprising at least one of a top protective cover or a bottom protective cover, the top protective cover configured to secure over a portion of the secondary cover to protect the liquid in the filter subsystem, and the bottom protective cover configured to thread onto the external threads of the tightening body cover to protect the filter cartridge from external particulates.

23. A liquid filtration system, comprising:
a filter subsystem configured to attach to external threads of a container opening of a container holding a consumable liquid, and to pass the liquid therethrough, the filter subsystem comprising:
a filter cartridge configured to pass the consumable liquid therethrough, the filter cartridge comprising a top endcap, a bottom endcap, a filter media secured between the top endcap and the bottom endcap, and a central liquid pathway internal to the filter media and which extends between the top endcap and bottom endcap;
an attachment mechanism comprising a tightening body, the tightening body comprising an annular center with a top opening having external threads and a bottom opening having internal threads, the tightening body configured to receive the bottom endcap of the filter cartridge through the top opening, through the annular center, and through the container opening, and further configured to position the top endcap against the top opening of the annular center, the internal threads of the tightening body are configured to tighten directly onto the external threads of the container opening;
the attachment mechanism further comprises a secondary cover configured with internal threads and external threads distal to the internal threads, the internal threads of the secondary cover tighten onto the external threads at the top opening of the tightening body to secure the top endcap of the filter cartridge against the top opening of the tightening body, the top endcap of the filter cartridge fabricated as a top endcap gasket having a beveled opening, the beveled opening configured to compressively seal against an internal bottom part of a secondary cover, the internal bottom part located above the internal threads of the secondary cover;
a draw-through object proximate the external threads of the secondary cover, the draw-through object configured to enable access to the consumable liquid from the filter cartridge; and
a riser part configured as part of the attachment mechanism, the riser part of a specified length and configured to accommodate a filter cartridge compatible with the specified length, the riser part further configured to capture the top endcap of the filter cartridge to form a captured filter cartridge, when installed internal to the riser part, the length of the captured filter cartridge extends at least one of above the container opening or below the container opening.

24. The liquid filtration system of claim 23, wherein at least one of the draw-through object, the riser part, the filter cartridge, or attachment mechanism are fabricated as a single unit, which single unit can be replaceable and recyclable.

25. The liquid filtration system of claim 23, wherein the riser part is configured to receive one of multiple different filter cartridges of different lengths, the riser part and received filter cartridge further configured to install proximate the top of the tightening body and proximate the bottom of the secondary cover.

26. The liquid filtration system of claim 25, wherein the specified length of a first filter cartridge ranges from about one inch to about three inches, the specified length of a second cartridge ranges from about three inches to about six inches, and the specified length of a third cartridge ranges from about six inches to about nine inches.

27. The liquid filtration system of claim 23, the bottom endcap further comprising a valve configured to toggle open and closed to enable pressure equalization between internal atmosphere of the container and an external environment of the container.

28. The liquid filtration system of claim 23, further comprising a disc filter configured to install between the top endcap and the bottom of the secondary cover to provide at least one of filtering or additional filtering of the container liquid.

29. A method of liquid filtration, comprising:
receiving a filter cartridge of a length based on dimensions of a container and container opening;
determining an upper portion length of the filter cartridge to position above the container opening and determining a remaining lower portion length of the filter cartridge to position proximate the container opening;
receiving a riser part which captures an upper endcap at the upper portion of the filter cartridge and encloses the upper portion length of the filter cartridge;
configuring a draw-through object as part of the riser part and proximate the upper endcap;
inserting the remaining lower portion length of the filter cartridge through the container opening;
securing a bottom end of the riser part directly to the external threads at the container opening; and
filtering micro-particulates from the consumable liquid as the consumable liquid passes through the filter cartridge in response to user action relative to at least one of the container walls or the draw-through object.

30. The method of liquid filtration of claim 29, further comprising extending a lower endcap of the remaining lower portion length of the filter cartridge through the container opening and further into a main body portion of the container.
